(19) United States
(12) Patent Application Publication
(10) Pub. No.: US 2023/0289887 A1
(43) Pub. Date: Sep. 14, 2023

(54) Optical Fraud Detector for Automated Detection Of Fraud In Digital Imaginary-Based Automobile Claims, Automated Damage Recognition, and Method Thereof

(71) Applicant: Swiss Reinsurance Company Ltd., Zürich (CH)

(72) Inventors: Abhinav GUPTA, Uttar Pradesh (IN); Amit ARORA, Princeton Junction, NJ (US); Riccardo TISSEUR, Aramengo (AT) (IT)

(73) Assignee: Swiss Reinsurance Company Ltd., Zürich (CH)

(21) Appl. No.: 18/052,033

(22) Filed: Nov. 2, 2022

Related U.S. Application Data
(63) Continuation of application No. PCT/EP2022/071406, filed on Jul. 29, 2022.

(30) Foreign Application Priority Data
Jul. 30, 2021 (CH) 070126/2021

(51) Int. Cl. G06Q 40/08; G06V 20/00

(52) U.S. Cl. CPC G06Q 40/08; G06V 20/95

(57) ABSTRACT

An automated automobile claims fraud detector and method for automatically evaluating validity and extent of at least one damaged object from image data and detect possible fraud, the automated automobile claims fraud detector comprising the processing steps of: (a) receiving image data comprising one or more images of at least one damaged object; (b) processing said one or more images for existing image alteration using unusual pattern identification and providing a first fraud detection; (c) processing said one or more images for fraud detection using RGB image input, wherein the RGB values are used for (i) CNN-based pre-existing damage detection, (ii) parallel CNN-based color matching, and (iii) double JPEG compression (DJCD) detection using custom CNN; (d) processing output of (i) CNN-based pre-existing damage detection, (ii) parallel CNN-based color matching, and (iii) double JPEG compression detection using custom CNN as input for ML-based fraud identifier providing a second fraud detection; and (e) generating fraud signaling output, if the first or second fraud detection indicates fraud.

### CROSS REFERENCE TO RELATED APPLICATIONS

The present application is a continuation of International Patent Application No. PCT/EP2022/071406, filed Jul. 29, 2022, which claims priority to Swiss Application No. 070126/2021, filed Jul. 30, 2021, the contents of each of which are hereby incorporated by reference in their entirety.

### FIELD OF THE INVENTION

The present invention relates to devices, systems, and methods for automated detecting and/or assessing damage to an object such as, for example, a vehicle, wherein possible fraudulent manipulations of digital image and/or fraudulent claims are automatically detected. Thus, it relates to an optical fraud detector and detection device for automated detection of fraud in digital imaginary-based automobile claim processing and automated damage recognition systems. In addition, it relates to devices, systems, and methods for detecting/analyzing/assessing damage to an object such as, for example, a vehicle providing estimates on repair/replacement costs, as well as, in addition to the evaluation on potential image manipulation and fraud. In particular, the present invention relates to a fully automated method for detecting and/or assessing damage to an object from image data provided by a user. Further, the present invention relates to a recognition apparatus and a recognition method based on image processing for automated damage identification for vehicle or property damages. Furthermore, the present invention also generally relates to image based damage recognition for processing damage claims by an insurance system.

### BACKGROUND OF THE INVENTION

### (A) Automated Automobile Claims Fraud Detector

When insured property is damaged, the owner may file a claim with the risk-transfer system or insurance company concerned with the risk-transfer. However, conventional processing of insurance claims is a complex process including, inter alia, the involvement of experts such as accident assessors in order to inspect, analyze and assess any damage to the insured object and provide the amount of damage, as well as costs required to repair or replace the damaged object. Thus, there is a heavy reliance on manual inspections by an expert to provide a repair cost estimate, which may come with significant cost and delay in processing time, as a person (assessor) must view the asset in order to assess the damage and decide upon an outcome, e.g. view a vehicle, and decide if the vehicle is repairable or not. Further, an insured may want to know the full extent of the damage before involving the insurance or assessor in order to decide, whether it is worth submitting an insurance claim or more cost effective to simply pay the cost of repair themselves. For instance, is the damage panel repairable or does it need a replacement.

There has been some advancement across the industry over the last years in the use of images to assist with assessing vehicles or other property without the need of a physical inspection. However, these advancements still rely on the technical expertise required to first capture suitable images (e.g. required technical standard format) and then incorporate the images with additional data from third parties, to allow a trained assessor or engineer to manually inspect the images and generate, for example, a repair estimate report. This is a costly, time consuming process particularly when there are finite technical resources. In the prior art, there are also systems allowing a consumer to capture the images in accordance with given instructions and process the initial claim by providing detailed information of the damage (e.g. following a protocol of questions to determine the location, type, and description of the damage), making the process very time consuming and very subjective to the consumer's incentive.

First is to be noted, that fighting against insurance fraud is a challenging problem both technically and operationally. It is reported that approximately 21%-36% auto-insurance claims contain elements of suspected fraud but only less than 3% of the suspected fraud is prosecuted. Traditionally, insurance fraud detection relies heavily on auditing and expert inspection. Since manually detecting fraud cases is costly and inefficient and fraud need to be detected prior to the claim payment, data mining analytics is increasingly recognized as a key in fighting against fraud. This is due to the fact that data mining and machine learning techniques have the potential to detect suspicious cases in a timely manner, and therefore potentially significantly reduce economic losses, both to the insurers and policy holders. Indeed there is great demand for effective predictive methods which maximize the true positive detection rate, minimize the false positive rate, and are able to quickly identify new and emerging fraud schemes.

In summary, conventional insurance claims processing is a complex process that typically starts with a first notification of loss related to an insured item. Upon notification of loss, the claim may be routed to multiple claims adjusters that analyze different aspects of the damage associated with the insured item in order to determine whether compensation for the loss is appropriate. In general, conventional claims adjustment can involve paperwork processing, telephone calls, and potentially face-to-face meetings between claimant and adjuster. In addition, a significant amount of time can elapse between a first notice of loss from the claimant and the final settlement of the claim. In addition, while consumers may take advantage of conventional claims processing to determine if they will receive any compensation for loss associated with an item, consumers have traditionally had very few options for obtaining advice associated with loss prior to submission of an insurance claim. Moreover, traditional claims processing often requires multiple actors sharing numerous documents. Accordingly, there may be a need for efficient and fraud-robust claims processing to better serve customers.

Thus, there is a need to extend prior art systems to allow assessing damage to an object from any image data provided by a user and further allowing to automatically detect possible fraudulent image manipulations or fraudulent claims.

In general, automotive risk-transfer, i.e. automobile insurance, is a contract-based relation between a user and a risk-transfer-system, as a first-tier insurance system, that provides monetary-based protection against physical damage or bodily injury resulting from traffic collisions, a possibly occurring liability that could also arise from incidents in a vehicle, against theft of the automobile, damage to the vehicle sustained from events other than traffic collisions, such as weather or natural disasters, and/or damage sustained by colliding with stationary objects. In other words, the automobile risk-transfer protects the user against and mitigates the risk of monetary loss in the event of an accident or theft. If there is damage to the automobile due to accidents or thefts, the user can claim the automobile insurance to fix the damages in a service center. The process for claiming the automobile insurance is a long process. The user has to file the automobile insurance for damages to the automobile, provide evidence, wait for an insurance underwriter or an insurance verifier to inspect and report the automobile and the damages to the insurance firm. The risk-transfer underwriter or the insurance verifier is a professional contracted by the insurance firm assigned to gather information associated with an automobile incident. The insurance firm may then initiate an adjudication process to determine an amount that is to be paid to the user. The process is lengthy and time-consuming as it involves a requirement of physical verification by the insurance underwriter or an insurance verifier. It would sometimes take days to get the insurance underwriter or the insurance verifier to inspect the automobile.

With the world becoming increasingly digitized, some of the insurance claiming process has been implemented online. The insurance firms maintain portals in which the user can buy the automobile insurance, maintain and claim the automobile insurance online. The portals reduce the paperwork required and allow the user to claim the automobile insurance online. The user can provide input about the automobile incident, upload images of the automobile, and provide such information online. The insurance firm may process the input, the images, and information and perform the adjudication process. As a result, the time is significantly reduced for claiming process, making it easier for the user as well as the insurance firm to process information. However, with the process going online, claims leakage has also increased dramatically. One of the reasons for the increase in claims leakage is due to lack of ability to differentiate a real and tampered images. Also, with the ease of image editing tools in market, it has become easier for fraudulent to tamper the images with ease. The images are tampered to show non-existing damages, larger damages or pre-existing damages to claim insurance relief. It is difficult or impossible to identify such tampered images by a human. Claims leakage is defined as a difference between an actual claim payment made and an amount that should have been paid to a claimant if best industry practices were applied. Insurance firms are using visual inspection and validation methods to reduce such fraudulent acts. Also, with visual inspection and validation methods, time required to process the automobile insurance claims has also increased.

It is important to reduce the claims leakage while also reduce the time required to process the automobile insurance claims. To reduce the claims leakage is a technical challenge due to easily available image processing tools that enable high-quality image processing. It is difficult to identify a tampered images and differentiate them with a normal image. It requires a technical ability to analyze and/or process the images to identify fraudulent insurance claims.

There are existing systems that involve detecting image alteration using “EXIF” data (see WO2018/055340A1). This system performs detection of potential fraud based on utilizing specific information extracted from image data. Also, this existing system uses information received from suitable databases (i.e. Industry Fraud Databases, such as, but not limited to, the Insurance Fraud Register, the Motor Insurance Database, the DVLA, vehicle register or VIN check to check the history of a vehicle, checking the vehicles insurance claim history), and other useful information etc. However, the system relies on the databases to obtain information to determine fraudulent activities.

Another existing technology involves a method based on performing frequency-domain transforming on the acquired photo based on a two-dimensional discrete cosine transform function (see CN105405054A). Thereafter, according to a preset analysis rule and based on a color value of the photo subject to the frequency-domain transforming in each color channel, the method requires performing authenticity verification on the photo. If the acquired photo is real, identifying photographing time of the acquired photo; extracting claim event occurrence time filled in the claim application corresponding to the acquired photo. And when the extracted claim event occurrence time does not match with the identified photographing time, generating reminding information to remind that the fraudulent conduct exists in the claim application corresponding to the acquired photo. In other words, the 054' application performs authenticity verification using frequency domain color channel analysis and time stamp matching.

The above techniques require time and are challenging to implement. With advances in computing technologies such as Artificial Intelligence (AI), machine learning, and deep learning algorithms, one can use these advanced computing technologies for fraud detection. However, it requires a technical ability to understand various fraudulent practices, identifying appropriate technology to usage of aforementioned technologies and their application to prevent fraudulent claims.

### (B) Automated Damage Recognition

Methods for automated identification of damages at vehicles or other property subjects based on digital image processing are important for a fast and reliable assessment of the damage for processing damage repairs and any claims resulting from the damaging. In particular, digital image and/or optical sensory data based insurance processing has become an important area with large scope for automation, which can be applied to different fields of risk-transfer technology, as car insurance claim processing, property insurance claim processing, cyber insurance risk assessment etc. For example, when insured property, as e.g. a car or an estate etc., is damaged, the owner may file a claim with the insurance company. However, conventional processing of the risk-transfer claim is a complex process including, inter alia, the involvement of experts such as accident assessors in order to inspect, analyze and assess any damage to the insured object and provide the amount of damage, as well as costs required to repair or replace the damaged object. Thus, there is a heavy reliance on manual inspections by an expert to provide a repair cost estimate, which may come with significant cost and delay in processing time, as a person (assessor) must view the asset in order to assess the damage and decide upon an outcome, e.g. view a vehicle, and decide if the vehicle is repairable or not.

Furthermore, image and/or optical sensory data related to a vehicles or property damage can be of poor quality or completely overlook certain aspects of a damage. Known image processing techniques to determine damages can include information deficiencies and false damage classifications which may result in incorrect damage remedy measures. Image based digital claim processing is an important area with a large scope for automation, which can be applied to different fields of risk-transfer technology, as car insurance claim processing, property insurance claim processing, cyber insurance risk assessment etc.

Digital image processing is all about digital images and/or other optical sensory data, data processing structures enabling the technical handling and processing of the digital image data. Herein, digital images and digital image processing are distinguished. Compared to digital images, an analog image is a two-dimensional relation and structure of spatial plane coordinates x and y and an intensity at each point. When the spatial coordinates and the intensity at each point are finite discrete quantities, then the image is defined as a digital image. Digital image processing is the processing of digital images with a digital data processing system or computer. Each digital image is composed of a finite number of elements, each with a particular location, called pixels. Digital image processing is an important technical field for engineers and scientist who acquire, manipulate, measure, compare, restore, compress, analyze, and data mine images. One feature of a digital image is its scale invariance, i.e. an infrared image of a galaxy, a magnetic resonance imaging MRI image of the brain, an optical microscope image of cells, an electron microscope image of nuclear pores, and an atomic force microscopy image of gold atoms on a graphite substrate all differ in scale, but they all can be subjected to the techniques of digital image processing. Another feature is the ubiquitous technical nature of digital image processing. For example, in the field of microscopic or endoscopic imaging, e.g. acquired with MRI, ultrasound, x-ray, and positron emission tomography techniques can be subjected to image processing for enhancement, segmentation, measurement, and compression. The key point is that digital image processing can be applied to any digital image. This does not dependent on the scale of the image, nor on the type of instrument that is used to obtain the image. Digital images are acquired or measured by optical sensory devices, digitally processed, and displayed. The human eye and the visual system may enter the domain of digital image processing since visual perception can be an important component of the process as well as the subjective assessment of image displays.

It has again to be pointed out that image recognition techniques, such as facial recognition, image searches, and optical character recognition, are used in many areas of risk-transfer automation. Although image recognition modeling is very complicated, the process from image data to prediction result is often not very different from that of traditional statistical modeling. Image recognition models, inter alia, may rely on stacked traditional statistical modeling to approximate the complicated relationship between input data and output data that is unlikely to be represented by simple functions. Most methods of normalization and regularization used in image recognition are also used in traditional models. The technical tools available in the prior art for developing image recognition make the use of such models possible for actuaries with a background in statistics.

As discussed above, automated image recognition may be applied to the risk-transfer industry in many areas. It can be used to improve automation of customer services, such as using facial recognition for identity verification and faster underwriting and claim processing. With satellite images, precise and automated agricultural risk-transfer pricing and risk assessment can be achieved with crop, weather, and landscape information for areas as small as a few kilometers. Automated home risk-transfer pricing may be improved as well using traditionally difficult-to-capture images of the insured property such as the roof. Extreme risk events such as floods, hurricanes, tornadoes, and wildfires can be monitored and the impact on risk-transfer claims updated in real time with the aid of automated image recognition. Medical images can provide richer information for health insurance underwriting and pricing. Optical character recognition can help digitize documents and facilitate information saving, searching, and sharing. There is no doubt about the advantages of using image recognition techniques in the long run. However, a few factors need to be considered. The amount of available data typically needs to be big, and the cost of data collection needs to be reasonable. The accuracy level of the applied modeling should be acceptably high, and the adverse impact of a wrong prediction should be manageable. The improvement of decision making needs to have sufficient financial benefits to offset the large investment in the techniques. As with the adoption of any new technology, it is a cost-benefit analysis to consider the investment of resources versus the gain from the application.

For automated risk-transfer, technical challenges also exist for a successful application of automated image recognition. Existing modeling techniques are usually trained to identify the objects in an image, but for risk-transfer applications, sometime useful information may be related the behavior of the object. This can lead to more customized model training using relevant image data. Data collection and model training may take a long time and require many resources. The current accuracy level of most advanced modeling techniques in the prior art is between 70% and 90%. However, in the field of risk-transfer, small error could lead to customer complaints and potential reputational risk. Cyber risk may also increase when automated image recognition techniques are used. For example, if facial recognition is used to confirm identification, the program may be hacked so that it accepts illegal requests and allows illegal access to private data.

In summary, there is a need for further technical developments to improve the applied modeling process accuracy, so the modeling processes become sophisticated enough to improve users' analysis and decision making. At the same time, image recognition provides many opportunities for actuaries. Equipped with both the industry knowledge and the technical skills, actuaries can help link image recognition with risk assessment and decision making in a meaningful way. They can help design image recognition model structures that can solve more complicated risk-transfer-related issues and help validate image recognition conclusions using existing models based on alternative data sources.

The publication “Automatic Car Insurance Claims Using Deep Learning Techniques” by Singh R. et al. discloses an end to end system to automate car insurance claim processing. The system takes images of the damaged car as input and gives relevant information like the damaged parts and provides an estimate of the extent of damage (no damage, mild or severe) to each part. This serves as a cue to then estimate the cost of repair which can be used in deciding insurance claim amount. The publication “Car Damage Detection and Classification” by Kyu P. M. discloses an image-based car insurance processing system applying multiple learning-based algorithms for car damage detection and assessment in real-world datasets. The algorithms detect the damaged part of a car and assess its location and then its severity. The system also uses domain-specific pre-trained CNN models, which are trained on an ImageNet dataset, and followed by fine-tuning, because some of the categories can be fine-granular to get specific tasks.

However, these systems rely on the quality of the original datasets and therefore the identification of damages using these datasets include deficiencies and inaccuracies related to the data used for the damage detection.

In the field of cyber security detection technology, such as anomaly detection for fraud recognition, it is known to use ensemble methods of combining learning algorithms. For example, the prior art document U.S. Pat. No. 11,005,872 B2 discloses a system providing for anomaly detection in cyber threats and fraud. The system captures records, each record having a corresponding number of attributes. It determines frequency measure for categorical attributes tags in the training portion of the plurality of records combining deep learning algorithms which is then used for probabilistic classifier in anomaly detection.

### SUMMARY OF THE INVENTION

It is one object of the present invention to provide an o provide a fully automatic fraud detector adapted to assess damage to an object from any image data provided by a user and detect possible fraudulent image manipulations or fraudulent claims.

It is a further object of the present invention to provide an apparatus or system, and method for automated damage identification and/or recognition for vehicle or property damages, which does not have the aforementioned drawbacks. In particular, it is meant to be possible to provide an apparatus and method for automated damage identification for vehicle or property damages that provides a high level of reliability and accuracy of the provided damage information, is overcomes deficiencies of damage data used for the damage identification and provides fast and reproducible damage information suitable for damage claim processing. More particularly, the automated car damage detection should be able to assess the claim process for faster processing with an advanced level of accuracy. The invention should be able to apply AI in claims processing providing model structures which can be well-trained with annotated damaged cars also based on a large amount and variety of training data sets. This is to detect the level of damage for accurate automated claim data processing.

According to the present invention, these objects are achieved, particularly, with the features of the independent claims. In addition, further advantageous embodiments can be derived from the dependent claims and the related descriptions.

### (A) Automated Fraud Detection

According to the present invention, the above-mentioned objects for an automated automobile claims fraud detector are achieved in that for automatically evaluating validity and extent of at least one damaged object from image data, characterized by the processing steps of: (a) receive connected car sensor data, and/or floating cellular data from mobile devices, and/or installed on-board unit devices (OBD devices) data; (b) process this data to predict/determine damage location zones and incident location/date/time, and other parameters; (c) receive image data comprising one or more images of at least one damaged object; (d) process said one or more images for existing image alteration using unusual pattern identification and providing a first fraud detection; (e) process said one or more images for fraud detection using RGB image input, wherein the RGB values are used for (i) CNN-based pre-existing damage detection, (ii) parallel CNN-based color matching, and (iii) double JPEG compression (DJCD) detection using custom CNN; (f) process output of (i) CNN-based pre-existing damage detection, (ii) parallel CNN-based color matching, and (iii) double JPEG compression detection using custom CNN as input for ML-based fraud identifier providing a second fraud detection; (g) study/combine all the above steps; and (h) generate fraud signaling output, if the first or second fraud detection indicates fraud. To realize the system, one or more data processing systems and/or computers can be configured to perform particular operations or actions by virtue of having software, firmware, hardware, or a combination of them installed on the system that in operation causes or cause the system to perform the actions. One or more executable codes can be configured to perform particular operations or actions by virtue of including executable instructions that, when executed by data processing apparatus, cause the apparatus to perform the actions. In one aspect, a system for detecting fraud in an automobile insurance claim is disclosed. The system includes one or more servers configured to: obtain the automobile insurance claim, the automobile insurance claim may include text data, one or more images associated with the automobile damage, and automobile and mobile sensor data, characterized in that the one or more servers configured to process the text data, the one or more images, and the automobile and mobile sensor data to determine an unusual damage pattern and an indication of fraud; and determine a fraud in the automobile insurance claim based on the unusual damage pattern and the fraud identifier. The unusual damage pattern is damage to the automobile that is unlikely to have happened to the automobile due to an accident. The indication of fraud is an indication that the one or more images are tampered.

In an embodiment variant, the generated fraud signaling output is verified, in a feedback-loop, by a human expert, wherein the verified signaling output is used for updating ML parameters of the CNN-based pre-existing damage detection and/or of the parallel CNN-based color matching and/or of the double JPEG compression detection using custom CNN.

In another embodiment variant, the disclosed method for automated detecting fraud in an automobile risk-transfer claim is disclosed can e.g. further comprise obtaining the automobile risk-transfer claim, the automobile risk-transfer claim comprising text data, one or more digital images associated with the automobile damage, and automobile and mobile sensor data. The method can e.g. comprise processing the text data, the one or more digital images, and the automobile and mobile sensor data to determine an unusual damage pattern and an indication of fraud and determining a fraud in the automobile risk-transfer claim based at least one of the unusual damage pattern and the indication of fraud. The unusual damage pattern is a damage to the automobile that is unlikely to have happened to the automobile due to an accident. The indication of fraud is an indication that the one or more digital images are tampered with. Other embodiments can e.g. comprise associated computer systems, apparatus, and computer program codes recorded on one or more computer storage devices, each configured to perform the actions of the methods.

Other embodiment variants and advantages of the inventive system and/or method will become apparent from the following detailed description, taken in conjunction with the accompanying drawings, which illustrate by way of example the teachings of the disclosure, and are not restrictive.

### (B) Automated Damage Recognition and Classification

Regarding the automated damage recognition, the present invention achieves this aim by providing a computer-vision based ensemble modelling data processing structure which provides a new technical approach to claim image processing by combining visual intelligence achieved via multiple computer vision models into a single domain, thereby improving the recognition of damage part and type classification, that either of the input, disparate computer vision models could have achieved. The inventive ensemble model structure utilizes a novel processing pipeline by amalgamating outputs of multiple visual models, and thus reducing individual model deficiencies and enhancing inference accuracy of each modelling structure. Preferably, the invention applies ensembled visual intelligence modelling to augment the data utilization. As a result, the proposed ensemble model structure achieves higher accuracy in detecting damaged parts and corresponding damage types on vehicles and property that is particularly useful for damage claim processing. As another advantage, the present invention can be based on training data for AI having precisely annotated images of different types of damaged vehicles which helps the present invention to train the machine learning structures more efficient.

In particular, these aims are achieved by an automated recognition system and method for automated damage recognition, identification and/or classification for vehicle or property damages based on image processing, wherein one or more images captured of one or more damage at a vehicle or property provide digital image data that is uploaded into the at least one data storage unit. In an image processing step the image data is processed by independently applying at least two different visual models to the image data to independently identify damaged parts of the vehicle or property and/or damage types at the vehicle or property, and wherein each visual model provides an independent subset of damage data corresponding to the identified damaged parts and/or damage types. In a combining step the subsets of damage data are automatically combined to define a single domain of damage data that provides enhanced inference accuracy for identifying damaged parts of the vehicle or property and/or damage types. Finally, damage information based on the single domain of damage data is provided that indicates damaged parts and/or damage types.

The single domain of damage data includes all data about damage parts and types identified by the at least two visual models. Preferably, the damage data of each subset is compared and data missing in one subset but present in another subset is included in the single domain of damage data. Further, the subsets of damage data are revised and for an identified damage only the damage data of higher quality is included into the single domain of damage data. Thus, the damage information gained from the damage recognition method according to the invention is completer and more reliable, and the inference accuracy can be improved.

In one alternative embodiment of the automated recognition system and method, in the image processing step the image data is prepared for the processing by the at least two different visual models in that the image data is provided with information about a damage case identifier, a damage part number and/or an image identifier. In the combining step these information can be compared, and the data can be allocated to a specific damage.

In a further alternative embodiment of the automated recognition system and method, the image processing step of at least one of the visual models provides steps of damage part identification, damage classification identification and/or assigning a damage confidence metric to the damage data. The step of damage part identification can for example be executed by e.g. realized by applying one or more supervised learning structures having during the learning phase recognized and classified damage parts, or the like. The step of damage class identification can for example be executed by applying a supervised learning structure with classified damage parts as input during learning phase or by applying an unsupervised machine-learning structure for the clustering by afterwards classifying the clusters by a feedback loop to a human expert or by using a supervised learning structure as above.

In still a further alternative embodiment of the automated recognition system and method, the image processing step of at least one of the visual models may provide steps of data cleaning and/or data correction including correction of the damage part identification and/or damage classification. For the present invention, prior art cleaning and correcting structure can be e.g. applied. However, in the context of the present invention, a new data cleaning technique for the effective removal of dirty data is introduced and can be used with the inventive system. This process involves the following two steps: (i) dirty data detection and (ii) dirty data cleaning. The dirty data detection process has been assigned with the following process namely, data normalization, hashing, clustering, and finding the suspected data. In the clustering process, the optimal selection of centroid is the promising one and is carried out by employing the optimization concept. After the finishing of dirty data prediction, the subsequent process: dirty data cleaning begins to activate. The cleaning process also assigns with some processes namely, the leveling process, Huffman coding, and cleaning the suspected data. The cleaning of suspected data is performed based on the optimization concept. Hence, for solving all optimization problems, a hybridized strucutre is proposed, called Firefly Update Enabled Rider Optimization Algorithm (FU-ROA), which is the hybridization of the Rider Optimization Algorithm (ROA) and Firefly (FF) algorithm. To the end, the analysis of the performance of the implanted data cleaning method is scrutinized over the other traditional methods like Particle Swarm Optimization (PSO), FF, Grey Wolf Optimizer (GWO), and ROA in terms of their positive and negative measures. From the result, it can be observed that the performance of the proposed FU-ROA model is improved over the existent PSO, FF, GWO, and ROA modelling structures, respectively.

In another alternative embodiment of the automated recognition system and method, at least one of the visual models provides steps of associating the damage data with a predefined damage nomenclature and/or predefined damage classification, wherein the predefined damage nomenclature and/or classification is selected from a master list of damage nomenclature. Preferably this step is executed during the image processing step and the assigned nomenclature and classification can be included in the single domain of damage data. The damage nomenclature and the damage classification can for example be defined by different damage claim categories, most common types of damages at vehicles or properties, inventory lists of vehicles or properties or other known features defining the vehicles, the properties, or the damage. This damage associating step is preferably executed during the image processing step and the assigned predefined damage nomenclature and/or predefined damage classification can be used in the combining step.

In one embodiment of the automated recognition system and method, in the combining step the single domain of damage data is processed by a gradient boosted decision tree model using at least two self-contained gradient boosted classifier models giving weighted damage data and amalgamating the weighted damage data to provide damage information as ensemble model output. As known, boosting is the process of converting weak learners into strong learners within machine-learning structures. Each new tree is a fit on a modified version of the original data set. The gradient boosting structure (gbm) processes data similar to an AdaBoost ML-structure. The process begins by training the decision tree in which each observation is assigned an equal weight. After evaluating the first tree, the weights of those observations are increased that are difficult to classify and lower the weights for those that are easy to classify. The second tree is therefore grown on this weighted data. The idea is to improve upon the predictions of the first tree. The system then determines the classification error from this second tree ensemble model and grow a third tree to predict the revised residuals. This process is repeated for a specified number of iterations. Subsequent trees help to classify observations that are not well classified by the previous trees. Predictions of the final ensemble model is therefore the weighted sum of the predictions made by the previous tree models. In the herein used Gradient Boosting, many models can e.g. be trained in a gradual, additive and sequential manner. The major difference is how the ML-structure identify the shortcomings of weak learners (e.g. decision trees). The herein proposed gradient boosting identifies the shortcomings by using gradients in the loss function (y=ax+b+e, e needs a special mention as it is the error term). The loss function is a measure indicating how good are model's coefficients are at fitting the underlying data.

In a further embodiment of the automated recognition system and method, the single domain of damage data and/or the ensemble model output are subject to human expert validation and a validation factor corresponding to the expert validation is fed into the combining step. This provides a machine learning loop based on human expert validation and correction feedback and the improved method can be applied to the subsets of damage data. The automated recognition system and method according to the present invention can for example use visual intelligence models for the at least two visual models used in the image processing step.

Furthermore, above defined aims are achieved by a recognition apparatus or system for automated damage identification for vehicle or property damages based on image processing, comprising a damage data upload section, at least one data storage unit, an image processing section, a damage identification section, and a damage information output section. The upload section is designed to receive one or more images captured of a damage of a vehicle or property in form of image data that is uploaded into the at least one data storage unit. The image processing section is designed to process the image data in an image processing step by independently applying at least two different visual models to the image data to independently identify damaged parts of the vehicle or property and/or damage types at the vehicle or property, wherein each visual model provides an independent subset of damage data corresponding to the identified damaged parts and/or damage types. The damage identification section is designed for automatically combining the subsets of damage data in a combining step to define a single domain of damage data that provides enhanced inference accuracy for identifying damaged parts of the vehicle or property and/or damage types. Finally, the damage identification output section is designed to provide damage information based on the single domain of damage data.

The recognition apparatus is particularly designed to utilize the recognition method according to the present invention as described above.

In one alternative embodiment the recognition apparatus comprises a comparison section, which is designed to check the individual subsets of damage data are for data deficiencies regarding the damaged parts of the vehicle or property in the combining step. Further, such data deficiencies in one subsets of damage data may be compensated by damage data of another subset of damage data to provide enhanced inference accuracy of the single domain of damage data. The data deficiencies in the damage data may be represented by data gaps, incorrect data assemblies, defective data chains and the like, which result in vague damage identification and insufficient damage information. Such unclear damage identification can be dispelled by using damage data from another subset of damage data.

In a further alternative embodiment of the recognition apparatus a data storage unit provides a master list of damage nomenclature and the single domain of damage data representing the identified damaged parts and/or damage types is compared to the master list of damage nomenclature to associate the identified damage to corresponding damage nomenclature.

In still a further alternative embodiment of the recognition apparatus the image data is further processed by a gradient boosted decision tree model as mentioned above.

In yet a further alternative embodiment the recognition apparatus is designed in that the damage information is subject to human expert validation and the combining step is augmented by a validation factor corresponding to the expert validation as described above.

In summary, the automated recognition system or apparatus and method according to the present invention in a first data preparation/preprocessing cycle loads captured images and processes the images by applying different visual models, particularly by applying visual intelligence models. Preferably, the recognized damaged parts and types are combined into a common nomenclature using a corresponding master list.

In a preferred embodiment, the system and method processes the images further in a second data processing cycle using a gradient boosted decision tree model structure. In a further embodiment variant, the single domain of damage data or the ensemble model output is used to improve the machine learning of the method based on a human expert validation/correction feedback loop.

The present recognition method and system or apparatus provide, inter alia, a technically new way of automated damage identification and damage classification that provides refined damage analysis, improves, and accelerates claim processing, and enhances damage remedy.

It should be again stated that the present invention relates not only to the inventive method and the inventive apparatus, but also to a system for carrying out this method and a corresponding computer program product.

### BRIEF DESCRIPTION OF THE DRAWINGS

The present invention will be explained in more detail below relying on examples and with reference to these drawings in which:

FIGS. 1 to 9 related to the inventive automated fraud detection, whereas FIGS. 10 to 17 related to the inventive automated damage recognition

FIG. 1 shows a block diagram, schematically illustrating an exemplary architecture of a system for detecting fraud in an automobile insurance claim, according to some embodiments.

FIG. 2 shows a block diagram, schematically illustrating exemplary zones of a car, according to some embodiments, i.e. an exemplary car damage zones reference diagram.

FIG. 3 shows a flow diagram, schematically illustrating an exemplary process for determining fraud in the automobile insurance claim, according to some embodiments.

FIG. 4 shows a flow diagram, schematically illustrating an exemplary determination of an unusual damage pattern, according to some embodiments.

FIG. 5 shows a block diagram, schematically illustrating an exemplary determination of an indication of the fraud, according to some embodiments.

FIG. 6 shows a block diagram, schematically illustrating an exemplary process flow for detecting a fraud in the automobile insurance claim, according to some embodiments.

FIG. 7 shows a block diagram, schematically illustrating an exemplary embodiment variant of the inventive automobile claims fraud detector detecting fraudulent claim requests inputted by an insured individual over a claim portal of an insurer, where the insured uploads digital images of damages to an insured vehicle and the automobile claims fraud detector detects manipulated or fraudulent images being part of the claim request, and where loss cover is denied if fraud is detected.

FIG. 8 shows a block diagram, schematically illustrating an exemplary overview of the inventive automobile claims fraud detector.

FIG. 8b shows a block diagram schematically illustrating an exemplary unusual pattern identification using business rules, in FIG. 1 referred as FIG. 1b.

FIG. 8d shows a block diagram schematically illustrating an exemplary unusual pattern identification using business rules, in FIG. 1 referred as FIG. 1d.

FIG. 9 shows a block diagram of another embodiment variant, schematically illustrating an exemplary overview of a different variant of the inventive automobile claims fraud detector.

FIG. 10 shows a block diagram which schematically illustrates a first cycle of an exemplary processing flow of a recognition method according to the present invention, and

FIG. 11 shows a block diagram which schematically illustrates a second cycle of the exemplary processing flow of the recognition method according to FIG. 10.

FIG. 12 shows a block diagram which schematically illustrates an automated annotation for vehicle dent detection performed by the inventive automated recognition system.

FIG. 13 shows a block diagram which schematically illustrates an automated annotation for damage level detection performed by the inventive automated recognition system.

FIG. 14 shows a block diagram which schematically illustrates an automated annotation for damaged car body parts performed by the inventive automated recognition system.

FIG. 15 shows a block diagram which schematically illustrates an automated bounding of identified boxes for car damage detection performed by the inventive automated recognition system.

FIG. 16 shows a block diagram which schematically illustrates an automated semantic segmentation for car damage detection performed by the inventive automated recognition system.

FIG. 17 shows a block diagram which schematically illustrates an automated severity weighting for car damage detection performed by the inventive automated recognition system.

### DETAILED DESCRIPTION OF THE PREFERRED EMBODIMENTS

### (A) Automated Fraud Detection

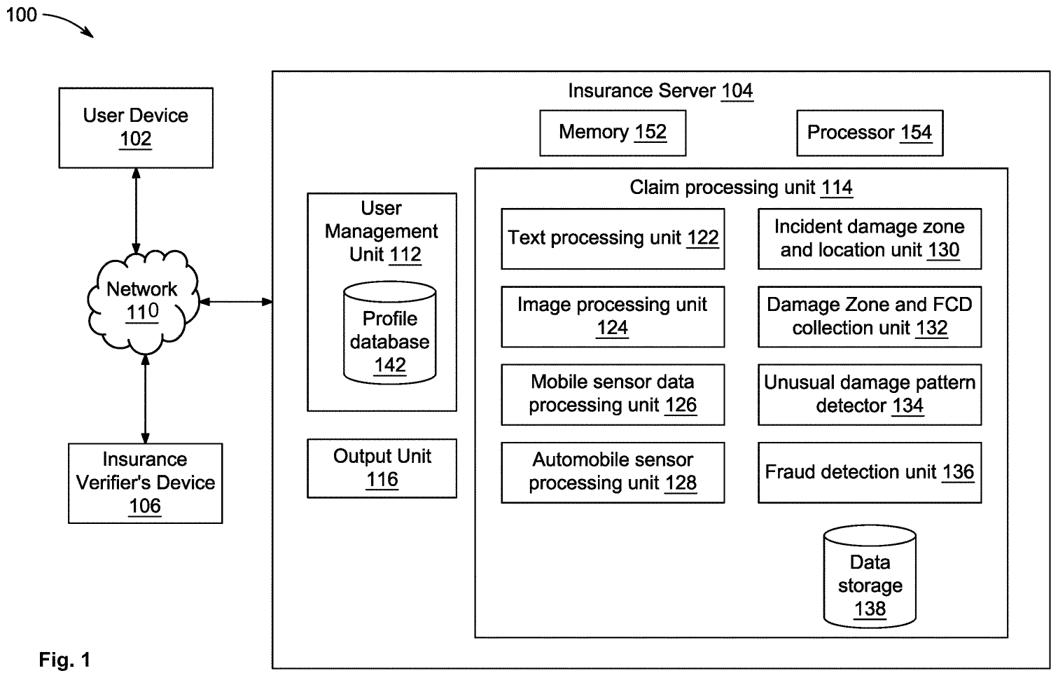

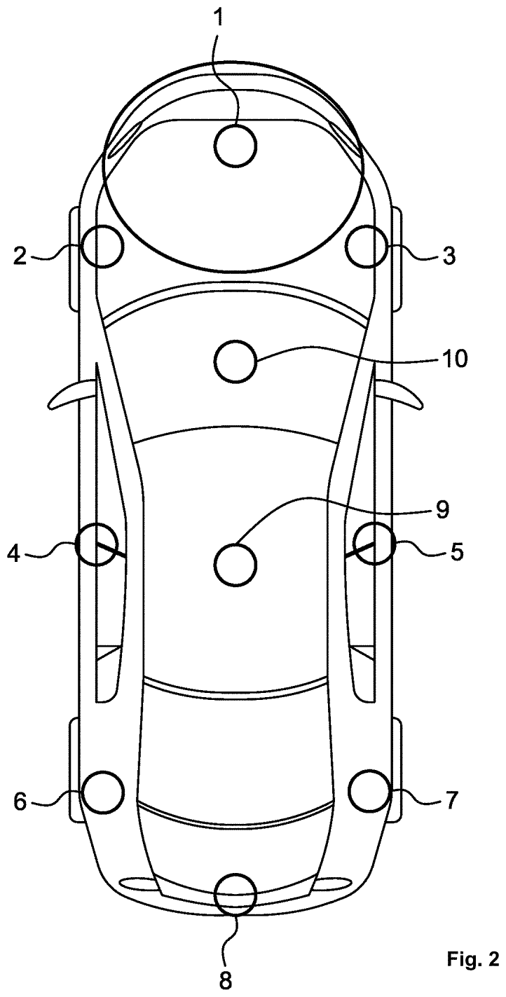

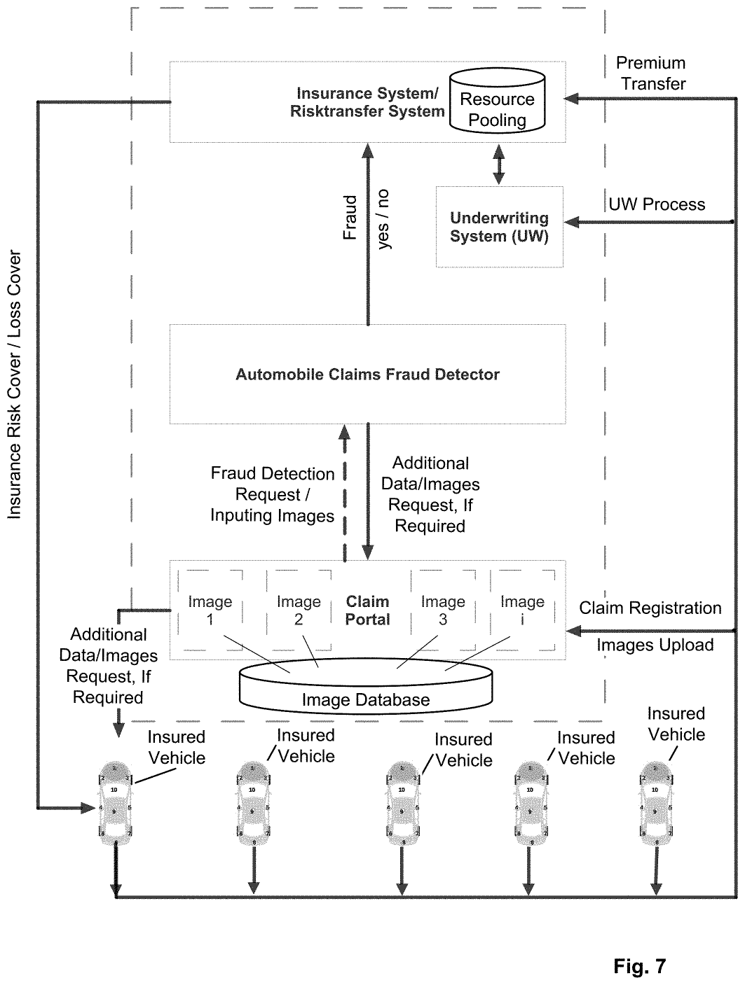

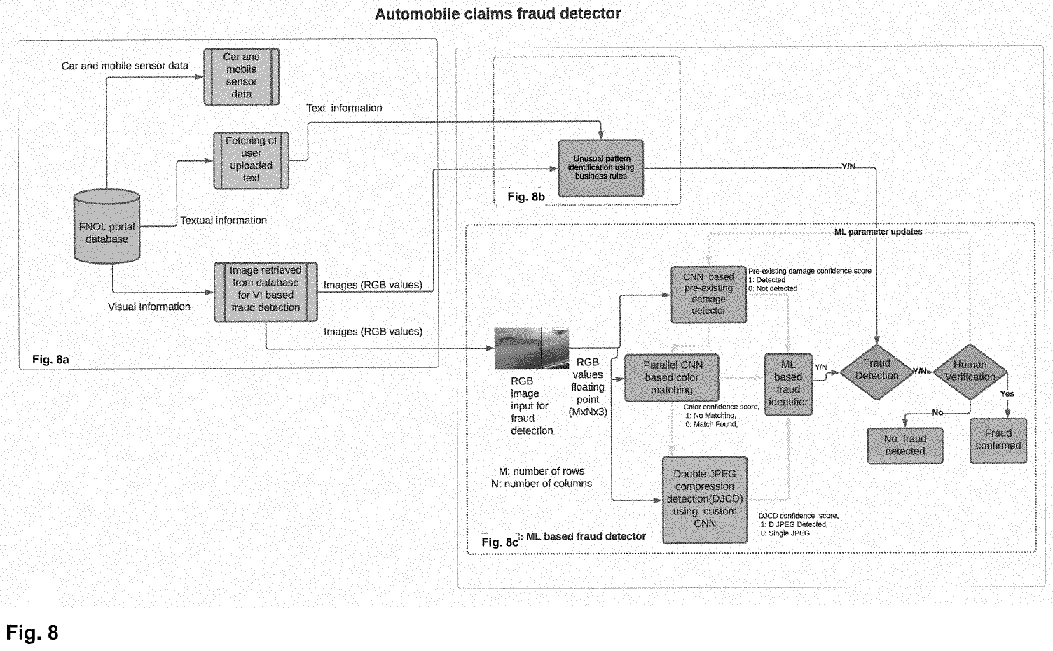

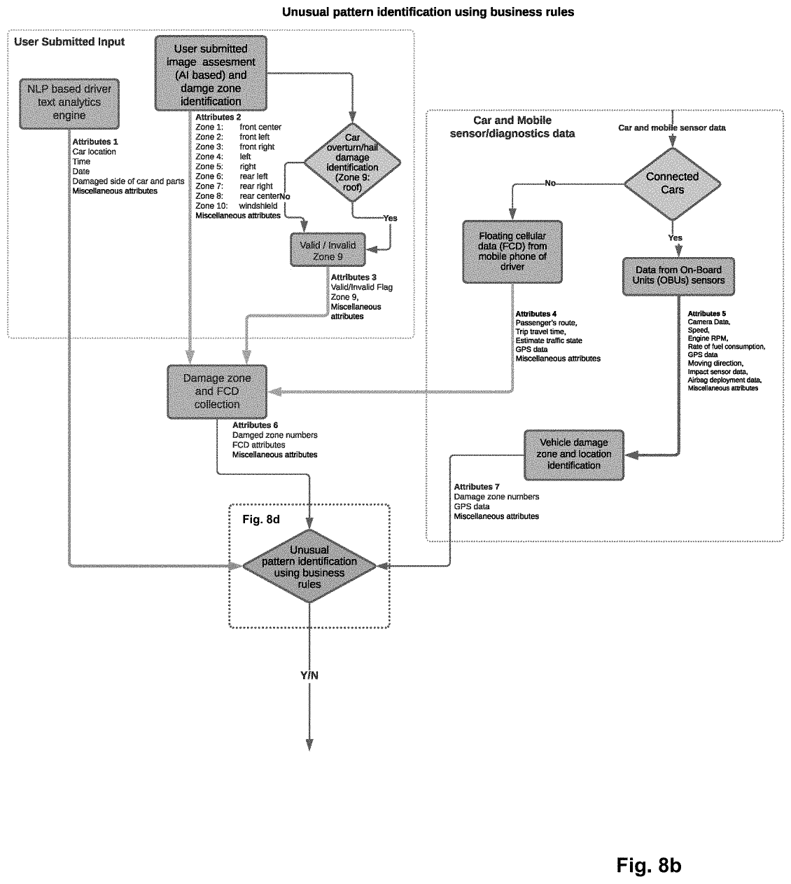

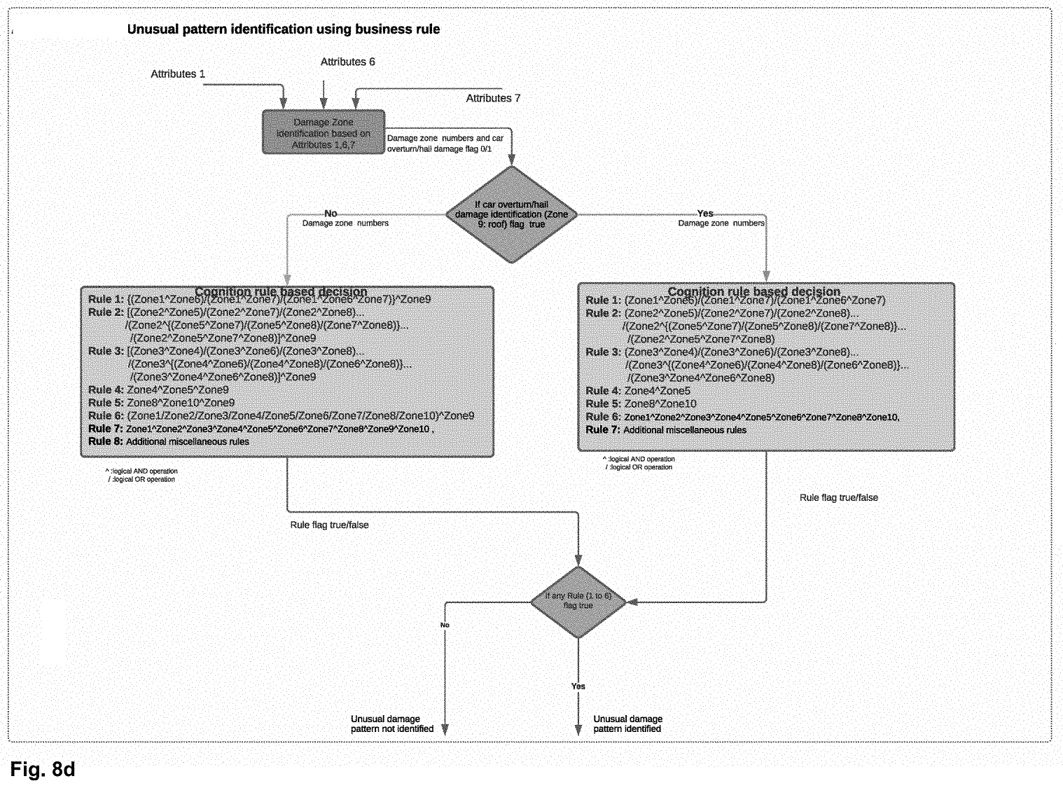

FIGS. 1 to 9 schematically illustrate an architecture for an automated automobile claims fraud detector according to the invention. The automobile claims fraud detector provides automated evaluation of validity and extent of at least one damaged object from image data, the automobile claims fraud detector comprising the processing steps of: (a) receive image data comprising one or more images of at least one damaged object; (b) process said one or more images for existing image alteration using unusual pattern identification and providing a first fraud detection; (c) process said one or more images for fraud detection using RGB image input, wherein the RGB values are used for (i) CNN-based (Convolutional Neural Network) pre-existing damage detection, (ii) parallel CNN-based color matching, and (iii) double JPEG compression (DJCD) detection using custom CNN; (d) process output of (i) CNN-based pre-existing damage detection, (ii) parallel CNN-based color matching, and (iii) double JPEG compression detection using custom CNN as input for ML-based fraud identifier providing a second fraud detection; and (e) generate fraud signaling output, if the first or second fraud detection indicates fraud. The generated fraud signaling output can e.g. be verified by a human expert, wherein the verified signaling output is used for updating ML parameters of the CNN-based pre-existing damage detection and/or of the parallel CNN-based color matching and/or of the double JPEG compression detection using custom CNN.

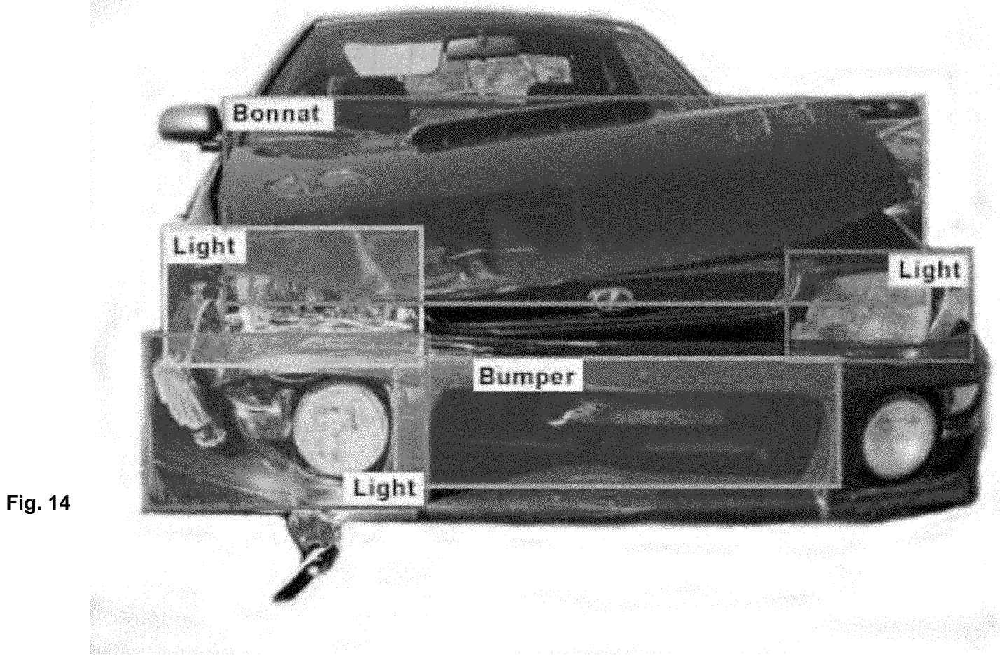

In accordance with various aspects of the disclosure (c.f. FIG. 14), methods and risk-transfer systems are disclosed through which risk-transfer and/or risk-transfer and/or claims may be automatically settled through an automated process. In certain aspects, when a claims processing server (as e.g. a claim portal of an insurer) receives data regarding an insured item (e.g., a vehicle, etc.) from a computing device (e.g., a mobile device, as a smart phone or a PC), the server processes the data and manages settlement of a claim request associated with the insured item. The automated system may utilize various hardware components (e.g., processors, communication servers, memory devices, sensors, etc.) and related computer algorithms to process image data related to damage associated with an insured item, determine if the image data conforms to a pre-determined set of criteria, analyze the image data to assess loss associated with the insured item, and determine if a payment is appropriate to the claimant as compensation for assessed loss. In particular, the automated automobile claims fraud detector automatically detects fraudulent manipulations of uploaded damage images, or other fraudulent claim requests associated with transmitted or uploaded digital damage images of an insured vehicle.

The claims processing server or claim portal may comprise a processor for controlling overall operation of the claims processing server and its associated components, including RAM, ROM, input/output module, and memory. I/O-device may include a microphone, keypad, touch screen, and/or stylus through which a user of enhanced claims processing server may provide input and may also include one or more of a speaker for providing audio output and a video display device for providing textual, audiovisual, and/or graphical output. Software may be stored within memory to provide instructions to the processor(s) for enabling the system to perform various functions. For example, memory may store software used by the system, such as an operating system, application programs, and an associated databases. Processor and its associated components may allow the system to run a series of computer-readable instructions to analyze image data depicting damage to an insured item (e.g., vehicle, etc.). Processor may determine the general location of damage associated with the vehicle by analyzing the uploaded images of the vehicle and, for example, further comparing these images with reference images of a similar vehicle with no damage or with similar damage. In addition, processor may assess the loss associated with the damaged vehicle and transmit terms for settling a risk-transfer claim related to the loss to a respective user's mobile device. The server may operate in a networked environment supporting connections to one or more remote clients, such as terminals, PC clients and/or mobile clients of mobile devices. The server can further comprise data stores for storing image data of insured items that have been analyzed by the claims processing server in the past. In particular, the terminals may represent mobile devices with built-in cameras for capturing image data associated with a damaged item.

Appropriate network connections can e.g. include a local area network (LAN) and a wide area network (WAN) but may also include other networks. When used in a LAN networking environment, the server can be connected to the LAN through a network interface. When used in a WAN networking environment, the server includes means for establishing communications over the WAN, such as the Internet. The existence of any of various well-known protocols such as TCP/IP, Ethernet, FTP, HTTP, and the like is presumed. Additionally, an application program used by the claims processing server according to an embodiment of the disclosure may include computer executable instructions for invoking functionality related to calculating an appropriate payment for assessed damage associated with an insured item. The claims processing server and/or terminals may also be mobile devices, as e.g. smart phones, including various other components, such as a battery, speaker, camera, and antennas.

The use of the risk-transfer server with the claim portal and the fraud detector may aid in cutting down time between a first notice of loss and settlement of the claim over the claim portal (e.g., real-time settlement of a claim) associated with the loss (e.g., via a payment and/or information regarding repair/replacement of an insured item). In addition, because the system discussed herein are automated and allow claims adjusters to inspect damages remotely or reduce the involvement of claims adjusters, less time and money may be spent to transport these adjusters to inspection locations. The automated nature of this process may also create the opportunity for remote human inspections of damage associated with insured items.

In particular, FIG. 1 depicts an architecture of a system 100 for automatedly detecting a fraud in an automobile insurance claim, according to some embodiment variants. According to the embodiment variant, the automated system 100 may include a user device/network-enabled client 102, an automated risk-transfer system resp. automated insurance system 104, a verifier's device 106, and a data transmission network 110, enabling digital communication between the system components for data exchange and transmission, in particular between an electronic claim-portal of the automated risk-transfer system 104 acting as a server device and the network enabled client device of the user accessing the claim portal via the data transmission network 110. In an embodiment variant, the user device 102 may be a device associated with a user who is filing an automobile insurance claim for a damage of the user's automobile, the automobile being associated with a conducted risk-transfer between the user and the automated risk-transfer system 104. The user device 102 may be any computing device, such as a mobile device, a smart phone, a tablet, a personal digital assistant, a laptop, or any other type and/or form of computing device that is capable of communication. In an example, the user may be a driver or an owner of the automobile. In an implementation, the user may use the user device 102 to access communication services including internet, voice, and data communication services. The user device 102 may also have an application or a browser installed on the user device 102 that enables the user to access the insurance server. The user may be a customer of an insurance organization providing insurance services, for example, through the automated risk-transfer system 104.

According to an embodiment variant, the automated risk-transfer system 104 may be a server providing the claim portal 1041being accessible via the data transmission network 110 by the user using his network-enabled client device 102 for automated support of the user in risk-transfer-related aspects. In an embodiment variant, the automated risk-transfer system 104 may be deployed and/or executed on any type and form of computing device, for example, a computer, network device, or appliance capable of communicating on any type and form of network (such as the network) and performing the operations described herein. In some embodiments, the automated risk-transfer system 104 may be implemented across a plurality of servers, thereby, tasks performed by the automated risk-transfer system 104 may be performed by the plurality of servers. These tasks may be allocated among the cluster of servers by an application, a service, a daemon, a routine, or other executable logic for task allocation. In an embodiment variant, the automated risk-transfer system 104 may be owned or managed or otherwise associated with an insurance company or any entity authorized thereof.

The automated risk-transfer system 104 may include a user management unit 112, a claim processing unit 114, and an output unit 116. The user management unit 112 may create profiles for new customers, manage existing customer profiles, and provide support to the customer on aspects related to the insurance through their individual profiles. The user management unit 112 includes a profile database 142 that stores user profile data including, but are not limited to, user information, user automobile information, user automobile insurance policy information, previous insurance claims and status of filed automobile insurance claims. In the context of the current disclosure, the user management unit 112 provides options to the user to file insurance claims related to automobile damage. For example, the user management unit 112 may provide a graphical user interface (GUI) to input automobile insurance details, automobile information, options to upload automobile damage images, and any additional information. In an example, the user management unit 112 may provide a first notice of loss (FNOL) through the GUI form to provide insurance claim-related input.

The claim processing unit 114 is configured to process the insurance claims filed by the user. The claim processing unit 114, inter alia, includes a text processing unit 122, an image processing unit 124, a mobile sensor data processing unit 126, an automobile sensor data processing unit 128 an incident damage zone, and location unit 130, an unusual damage pattern detector 134 and a fraud detection unit 136.

The text processing unit 122 processes text provided by the user in the claim associated with the risk-transfer to determine and/or recognize a first set of attributes. The first set of attributes includes at least one of the automobile location of the incident, a date of the accident, a time of the accident, the damaged side of car, the damaged parts, and such information. In one or more embodiments, the text processing unit 122 may use known and/or proprietary text processing techniques such as natural language processing (NLP) techniques to process the text.

The image processing unit 124 is configured to process the images input by the user to determine damages to one or more zones of the automobile and/or an indication of fraud. The indication of fraud may be evidence indicating that the images depicting the damages to one or more zones of the automobile or automobile parts may be tampered with or fake. In one or more embodiments, the image processing unit 124 may use artificial intelligence (AI), and image processing techniques such as a machine language (ML) based convolutional neural network (CNN) in determining damages to one or more zones of the automobile and/or an indication of fraud. The AI and ML-based CNN of the image processing unit 124 may be trained with a plethora of image data to identify the zones and the damages therein. As a part of determining damages to one or more zones of the automobile, in one or more embodiments, the image processing unit 124 may use the AI to determine a second set of attributes indicative of damage to one or more zones of the automobile. The second set of attributes identifies the zone and damage thereof to at least one zone of the one or more zones. The second set of attributes includes front center zone, front left zone, front right zone, left zone, right zone, rear left zone, rear right zone, rear center zone, and windshield zone. An example illustrating the zones of a car is provided in FIG. 2. Zone 1 may represent a front center zone of the car, zone 2 may represent a front left zone of the car, zone 3 may represent a front right zone of the car, zone 4 may represent a left zone of the car, zone 5 may represent a right zone of the car, zone 6 may represent a rear left zone of the car, zone 7 may represent a rear right zone of the car, zone 8 may represent a rear center zone of the car, zone 9 may represent a roof of the car, and zone 10 may represent a windshield zone of the car. The damages may include a dent, glass shatter, broken front lamp, broken tail lamps, scratch, smash, hailstone dents, and such damages. The image processing unit 124 may use the AI to determine a third attribute that details the damage to the automobile roof or the zone 9.

For an indication of fraud, the image processing unit 124 may use machine learning (ML) with the CNN to process the images. In one or more embodiments, the image processing unit 124 may use machine learning techniques and/or deep learning techniques with the CNN to identify pre-existing damage, parallel based color matching, and a double joint photographic experts group (JPEG) compression. Pre-existing damage may refer to the damage that existed on the automobile before the incident. Color matching may refer to comparing colors of different parts of the same image, which should have the same color. Color matching may also refer to comparing colors of the one or more images with previous provided images to determine whether the images indeed belong to the automobile for which the automobile insurance is claimed. Color matching may refer to comparing colors of the image with reference color values (e.g. provided as normed values, e.g. in values of RAL codes or the like), e.g. provided by the carmaker automobile manufacturer. The double JPEG compression may refer to tampering of images that causes recompression (that is, due to resaving the manipulated image in the JPEG format with a different compression quality factor) after digital tampering.

The mobile sensor data processing unit 126 may process the mobile sensor data to obtain a floating car data (FCD) from a driver driving the automobile or the automobile itself. The mobile sensor data processing unit 126 may process the FCD to determine a fourth set of attributes. The fourth set of attributes include at least one of a passenger's route, trip travel time, estimate traffic state, and global positioning system (GPS) data. In one or more embodiments, the mobile sensor data processing unit 126 may use techniques such as floating cellular data or GPS-based collection methods to obtain the FCD. The FCD may be a time-stamped geo-localization and speed data obtained from mobiles of the moving automobiles. In one or more embodiments, the FCD may provide a Lagrangian description of the automobile movements. The mobile sensor data processing unit 126 may obtain the mobile sensor data through data collected by mobile service providers, through applications that collect FCD data from the driver's mobile phone or such sources. In some examples, the mobile sensor data may be obtained from fleet vehicle service providers. The FCD includes at least a location data, and movement data.

The damage zone and FCD collection unit 132 may process the second set of attributes, the third attribute from the image processing unit 124, and the fourth set of attributes from the mobile sensor data processing unit 126 to obtain a sixth set of attributes. The sixth set of attributes include at least one of information of damage to one or more zones of the automobile and FCD.

The automobile sensor data processing unit 128 may acquire and process data from on-board unit (OBU) sensors of the automobile to obtain a fifth set of attributes. The fifth set of attributes include at least one of camera data, speed data, engine revolutions per minute (RPM) data, rate of fuel consumption, GPS data, moving direction, impact sensor data, and airbag deployment data. The OBU sensors may include a dashboard camera, speedometer, tachometer, flow sensor, GPS device, impact sensor, motion sensor, crash sensors, an accelerometer sensor, a gyroscope sensor and such sensors.

The incident damage zone and location unit 130 may process the fifth set of attributes to obtain a seventh set of attributes that provide damage information associated with the automobile and incident location information. The seventh set of attributes may include at least one of the information associated with damage to one or more zones of the automobile and the GPS data associated with the incident location.

As an embodiment variant, the damage zone and location unit 130 provides an automated object localization process. Object localization can be used for multiple purposes, such as, determining the location of a certain object within an image, and also to determine a damage (variance) within that certain object. For example, to obtain object localization, a “sliding window” technique can be used. A “sliding window” is obtained by creating small overlapping sub-sections of an image and classifying each one separately. In the event a sub-section is classified to contain an object, the corresponding area within that image is then classified as containing that object. This results in localized areas within the original image that are classified as either containing or not containing an object. Also, convolutional neural networks can also be used to perform the inventive object localization without the use of a sliding window. The later method includes (i) the “Fast Region-based Convolutional Network method” (Fast R-CNN) as described by “Fast R-CNN”, (ii) a “Unified, Real-Time Object Detection” (YOLO), and/or (iii) “Saliency Maps”, which are generically known in the prior art. Both the (i) and (ii) output bounding box predictions with confidence percentages for each bounding box containing objects upon which the networks have been trained to recognize. Saliency maps (iii) perform object localization estimations per pixel using back-propagation on a single classified image by applying a convolutional network architecture suitable for single image classification. The aim of a convolutional neural network for image classification is to be able to take raw pixel data as an input and return a correct classification for the main content within the image. For the present image classification, the input data can e.g. be an image of a pre-determined size and in either grayscale or RGB color space. A convolutional layer is applied to generate the output of neurons connected to local regions in the input, each computes a dot product between their weights and the small region they are connected to. Each convolutional layer can e.g. contain a number of these ‘convolutional filters’ producing multiple activations per image. Further, e.g. either a Relu (Rectified Linear unit) or Sigmoid function can be used as an activation function within the present convolutional network. A pooling layer can be used to down-samples the dimensions of the data (i.e. width, height). A SoftMax function (or normalized exponential) can be used to take an input vector (e.g. the last layer of fully connected neurons of the network) and returns a vector of length equal to that of the training classes with an element x for each class within the range 0≤x≤1 and such that Σᵢ₌₁ⁱ⁼ⁿxₙ=1, i.e. a probability value for each class.

The unusual damage pattern detector 134 is configured to receive and perform a first analysis and the second analysis on the first set of attributes, the sixth set of attributes, and the seventh set of attributes. The first analysis determines whether there are damages to one or more zones on opposite sides of the automobile when the third attribute indicates damage to the automobile roof. The second analysis determines whether there are damages to one or more zones on opposite sides of the automobile when the third attribute indicates that there is no damage to the automobile roof. Based on the first analysis and the second analysis, the unusual damage pattern detector may determine the unusual damage pattern in the automobile damage. The unusual damage pattern indicates a damage pattern to the automobile that may not have happened to the car in an accident, natural calamities, or such factors. For example, in an accident due to automobile collision where a car collides with a vehicle or an object from a front left side, the front left side would be damaged. A damage on back right side of the vehicle is unlikely as the collision is on the front left side, and if there is a damage to the back right side of the car, then that would indicate the unusual damage pattern.

The fraud detection unit 136 may process the indication of fraud and the unusual damage pattern obtained from the image processing unit 124 and the unusual damage pattern detector 134, respectively, to determine whether the claim of automobile insurance for automobile damage is fraudulent or not. The fraud detection unit 136 may determine that the claim of automobile insurance for automobile damage is fraudulent on determining that there is at least one of the unusual damage pattern and the fraud identifier.

The insurance verifier's device 106 may be any computing device, such as a mobile device, a smart phone, a tablet, a personal digital assistant, a laptop, or any other type and/or form of computing device that is capable of communication. In an example, the insurance verifier may be a professional who may be representative of the insurance firm or a third-party contracted by the insurance firm assigned to gather information associated with the automobile incident. In an implementation, the insurance verifier's device 106 may have an application or a browser installed on the user device 102 that enables the insurance appraiser to access the insurance server. The insurance verifier is a professional who may be a representative of the insurance firm or a third-party who is contracted by the insurance firm and assigned to gather information associated with the automobile incident.

According to an embodiment, the network may be a private network or a public network. Further, the network 110 may be connected via wired and/or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel or a satellite band. The wireless links may also include any cellular network standards to communicate among mobile devices, including standards that qualify as 1G, 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommuniations-2000 (IMT-2000) specification, and the 4G standards may correspond to the International Mobile Telecommunication Advanced (IMT-Advanced) specification. Examples of cellular network standards include AMPS, GSM, GPRS, UMTS, CDMA2000, CDMA-1xRTT, CDMA-EVDO, LTE, LTE-Advanced, LTE-M1, and Narrowband IoT (NB-IoT). Wireless standards may use various channel access methods, e.g., FDMA, TDMA, CDMA, or SDMA. In some embodiments, different types of data may be transmitted via different links and standards. In other embodiments, the same types of data may be transmitted via different links and standards.

Further, the network 110 may be any type and/or form of network. The geographical scope of the network may vary widely and the network 110 can be a body area network (BAN), a personal area network (PAN), a local-area network (LAN), e.g., Intranet, a metropolitan area network (MAN), a wide area network (WAN), or the Internet. The topology of the network 110 may be of any form and may include, e.g., any of the following: point-to-point, bus, star, ring, mesh, or tree. The network 110 may be an overlay network that is virtual and sits on top of one or more layers of other networks. Also, the network 110 may be of any such network topology as known to those ordinarily skilled in the art capable of supporting the operations described herein. The network 110 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv4 and IPv6), or the link layer. The network 110 may be a type of broadcast network, a telecommunications network, a data communication network, or a computer network.

According to some embodiments, the user device 102 and the insurance verifier's device 106 may include a processor and a memory. In an implementation, the processor may be any logic circuitry that responds to, and processes instructions fetched from the memory. In many embodiments, the processor may be provided by a microprocessor unit, e.g., those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The processor may utilize instruction-level parallelism, thread-level parallelism, different levels of cache, and multi-core processors. A multi-core processor may include two or more processing units on a single computing component. Examples of multi-core processors include the AMD PHENOM IIX2, INTER CORE i5, and INTEL CORE i7.

The memory may include one or more memory chips capable of storing data and allowing any storage location to be directly accessed by the processor. The memory may be Dynamic Random-Access Memory (DRAM) or any variants, including static Random-Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the memory may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The memory may be based on any of the above-described memory chips, or any other available memory chips capable of operating as described herein.

According to an embodiment, the user device 102 and the insurance verifier's device 106 may further include an operating system and a host of sensors. In an implementation, the operating system may be, for example, software including programs and data that manages hardware of the user device 102 and the insurance verifier's device 106 and provides services for execution of applications included in the mobile phone. Known examples of the operating system may include iOS®, Android®, Microsoft® Windows, and Linux.

According to an embodiment, the insurance server 104 may include a processor 154 and a memory 152. In an implementation, the processor 154 may be any logic circuitry that responds to, and processes instructions fetched from the memory 152. In many embodiments, the processor 154 may be provided by a microprocessor unit, e.g., those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The processor 154 may utilize instruction-level parallelism, thread-level parallelism, different levels of cache, and multi-core processors. A multi-core processor may include two or more processing units on a single computing component. Examples of multi-core processors include the AMD PHENOM IIX2, INTER CORE i5, and INTEL CORE i7.

The memory 152 may include one or more memory chips capable of storing data and allowing any storage location to be directly accessed by the processor 154.

The memory 152 may be Dynamic Random-Access Memory (DRAM) or any variants, including static Random-Access Memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the memory 152 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The memory 152 may be based on any of the above-described memory chips, or any other available memory chips capable of operating as described herein.

In an implementation, the text processing unit 122, the image processing unit 124, the mobile sensor data processing unit 126, the automobile sensor data processing unit 128, the incident damage zone and location unit 130, the damage zone and FCD collection unit 132, the unusual damage pattern detector 134, and the fraud detection unit 136 may be coupled to the processor 154 and the memory 152. In some embodiments, the text processing unit 122, the mobile sensor data processing unit 126, the automobile sensor data processing unit 128, the incident damage zone and location unit 130, the damage zone and FCD collection unit 132, the unusual damage pattern detector 134, and the fraud detection unit 136 amongst other units, may include routines, programs, objects, components, data structures, etc., which may perform particular tasks or implement particular abstract data types. The text processing unit 122, the mobile sensor data processing unit 126, the automobile sensor data processing unit 128, the incident damage zone and location unit 130, the damage zone and FCD collection unit 132, the unusual damage pattern detector 134, and the fraud detection unit 136 may also be implemented as, signal processor(s), state machine(s), logic circuitries, and/or any other device or component that manipulate signals based on operational instructions.

In some embodiments, the text processing unit 122, the image processing unit 124, the mobile sensor data processing unit 126, the automobile sensor data processing unit 128, the incident damage zone and location unit 130, the damage zone and FCD collection unit 132, the unusual damage pattern detector 134, and the fraud detection unit 136 may be implemented in hardware, instructions executed by a processing unit, or by a combination thereof. The processing unit may comprise a computer, a processor, a state machine, a logic array or any other suitable devices capable of processing instructions. The processing unit may be a general-purpose processor that executes instructions to cause the general-purpose processor to perform the required tasks or, the processing unit may be dedicated to performing the required functions. In some embodiments, the text processing unit 122, the image processing unit 124, the mobile sensor data processing unit 126, the automobile sensor data processing unit 128, the incident damage zone and location unit 130, the damage zone and FCD collection unit 132, the unusual damage pattern detector 134, and the fraud detection unit 136 may be machine-readable instructions which, when executed by a processor/processing unit, perform any of the desired functionalities. The machine-readable instructions may be stored on an electronic memory device, hard disk, optical disk, or other machine-readable storage medium or non-transitory medium. In an implementation, the machine-readable instructions may also be downloaded to the storage medium via a network connection. In an example, the machine-readable instructions may be stored in memory 152.

In some embodiments, the insurance server 104 may include a data storage 138. In an implementation, the data storage 138 may store information related to, for example, image dataset, training data, testing data, machine learning models, and such information. In an implementation, information stored in the data storage 138 may be periodically or dynamically updated as required.

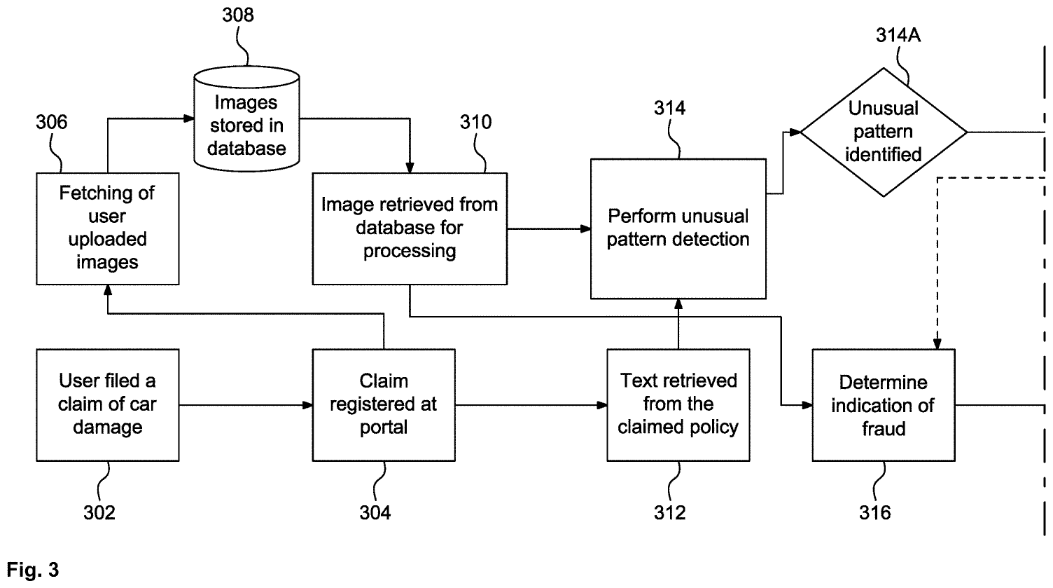

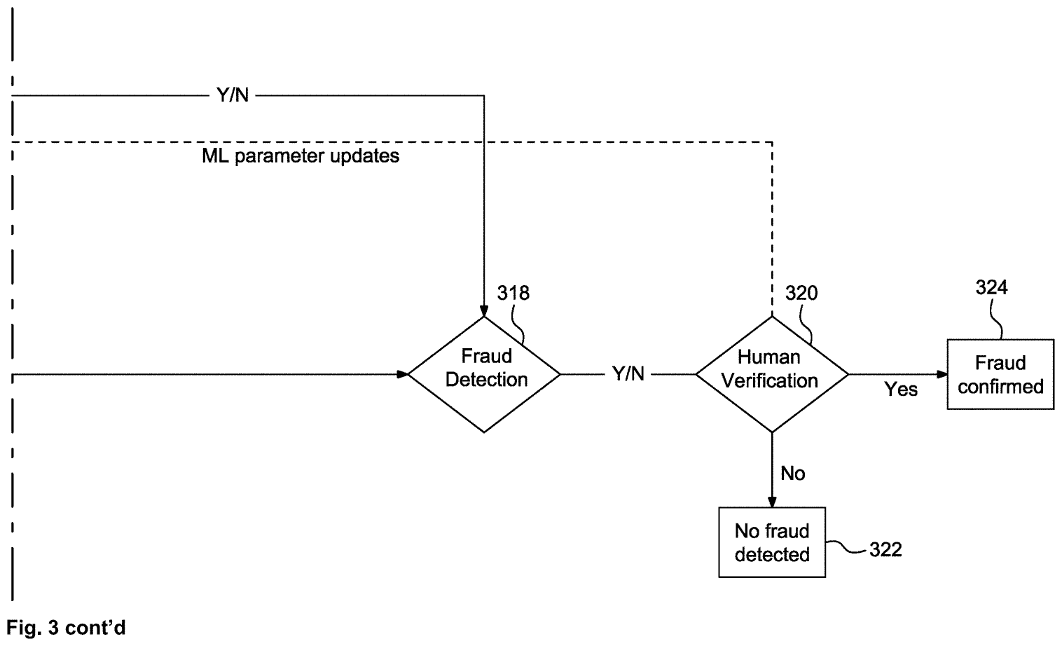

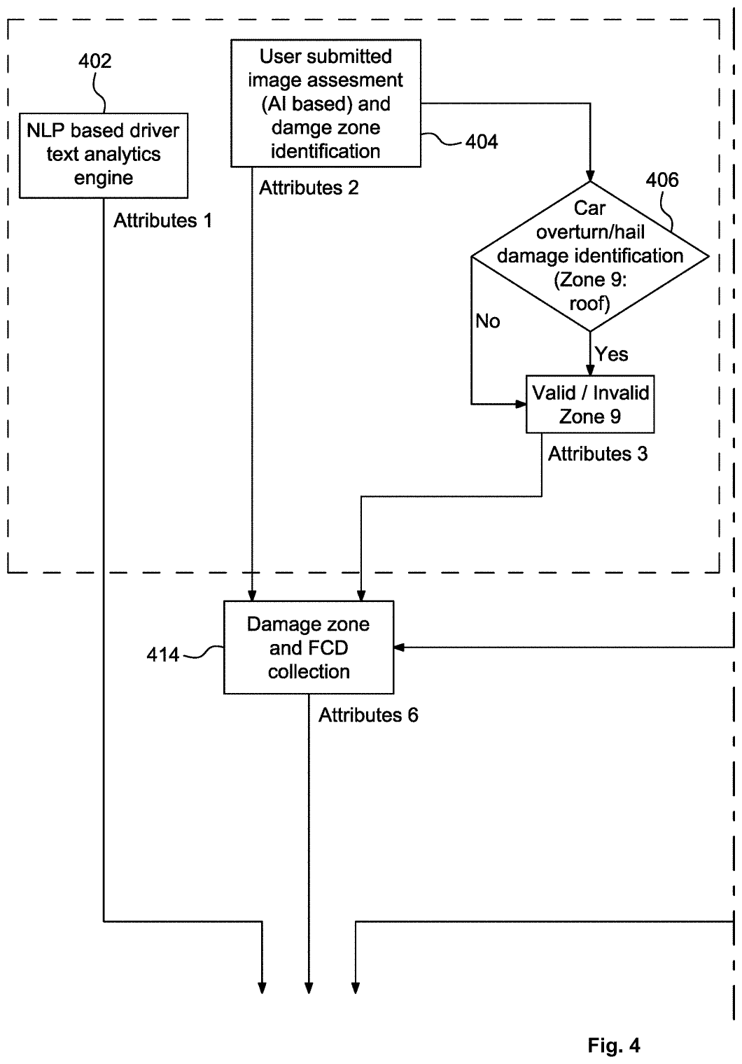

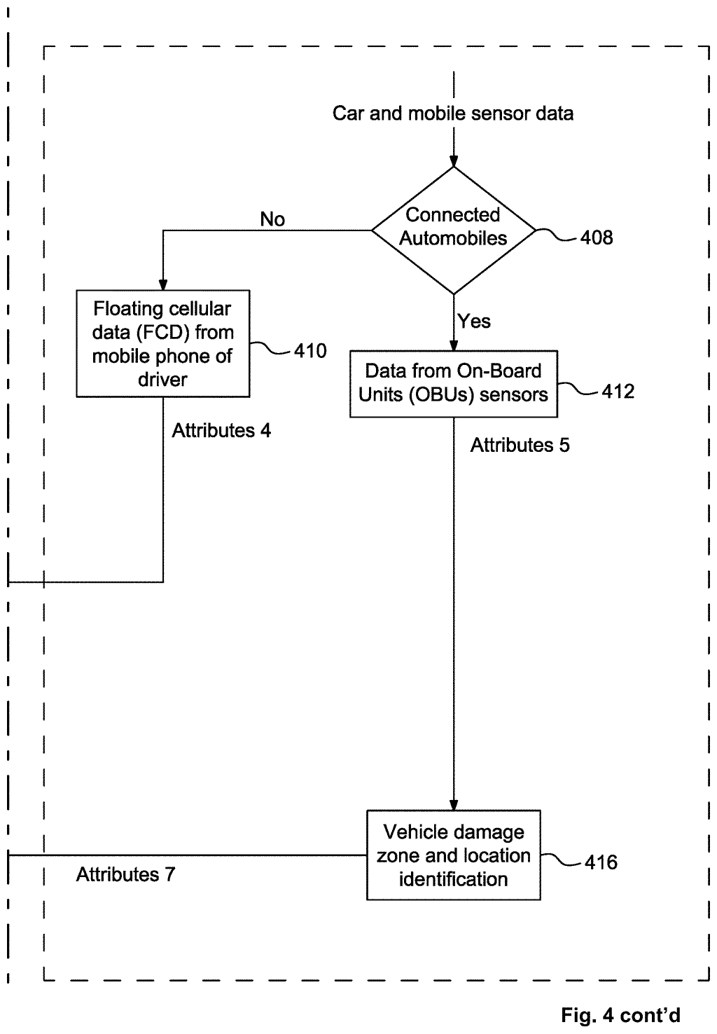

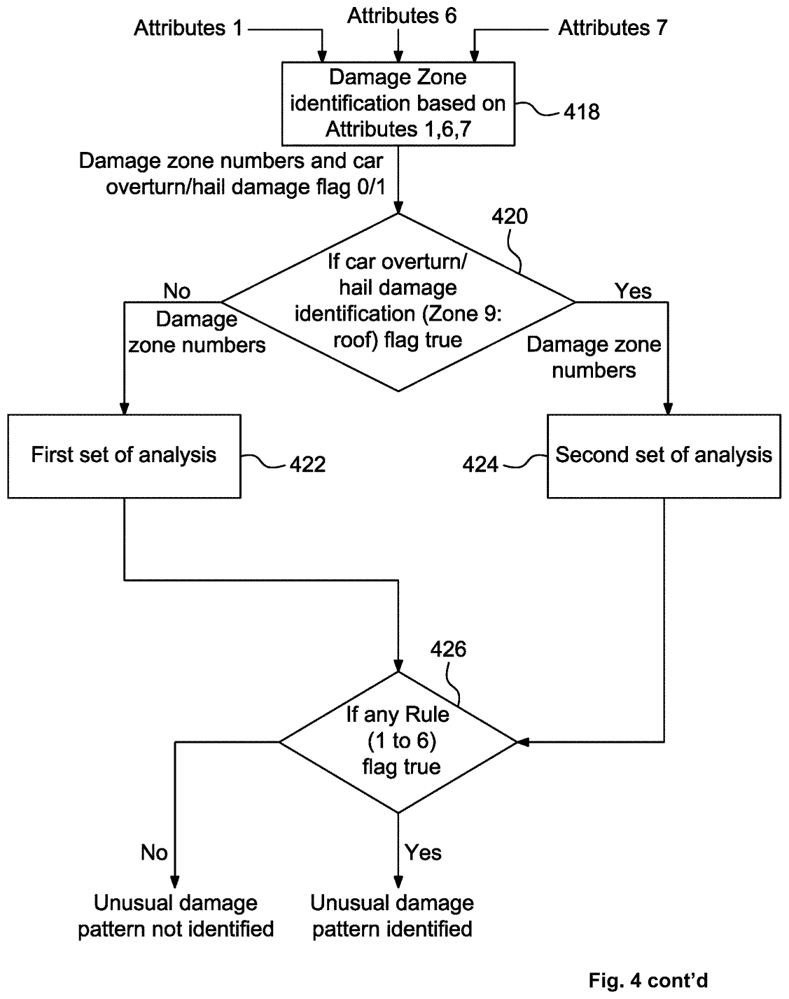

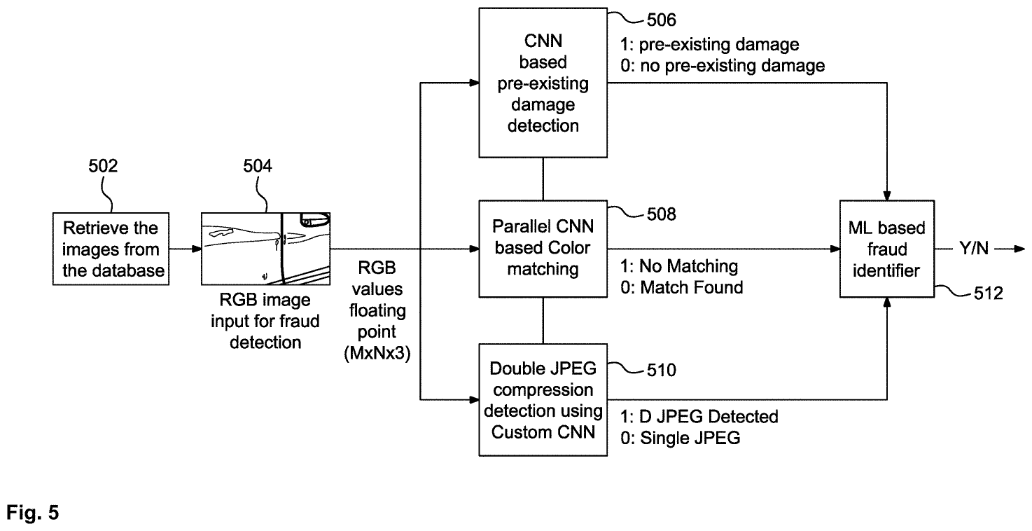

The user may have an automobile insurance policy for an automobile with the insurance firm. The automobile may be involved in an incident, causing damages to the automobile. The incident may be an accident, natural calamity, or such incidents. The accident may be an event where the automobile is involved in a collision with another automobile or involved in a collision with a pedestrian or another object. The natural calamity may be a tornado, earthquake, flood, and such calamities. The user may want to claim compensation for the damages using the automobile insurance policy. According to an embodiment, the user may log in to the profile in the insurance server 104 to file the automobile insurance claim. The insurance server 104 may provide a first notice of loss (FNOL) form to inform the insurance service provider about the incident and a potentially covered loss. The insurance server 104 may provide a GUI to input details associated with the incident and damages to the automobile. The FNOL form may enable the user to file a draft claim or an open claim. The draft claim may be a claim having basic incident information and but not enough information for the insurance server 104 or the insurance firm claim to enter an adjudication process. The open claim may be a claim that may have enough information for the insurance server 104 or the insurance firm to enter the adjudication process. In instances where the user is unable to provide enough information in the FNOL form, the insurance server 104 may register the claim as the draft claim and may allow the user to provide more details at a later point in time. In instances where the user is able to provide enough information in the FNOL form, the insurance server 104 may register the claim as the open claim. The user may file the claim by providing details of the incident through text data, and/or uploading one or more images capturing damages to the automobile. The insurance server 104 may also obtain the mobile sensor data and the automobile sensor data from the driver's mobile information and the automobile, respectively. In some examples, the insurance server 104 may obtain the mobile sensor data and the automobile sensor data from various sources that may include a third party. The insurance server 104 may process the automobile insurance claim for detection of fraud. The insurance server 104 may process the text data, the one or more images, the mobile sensor data, and the automobile sensor data to determine the unusual damage pattern and the indication(s) of fraud. In one or more embodiments, the insurance server 104 may utilize the text processing unit 122, the image processing unit 124, the mobile sensor data processing unit 126, the automobile sensor data processing unit 128, the incident damage zone and location unit 130, the damage zone and FCD collection unit 132, the unusual damage pattern detector 134, and the fraud detection unit 136, appropriately to process the automobile insurance claim for detection of fraud. A process of determining a fraud in automobile insurance is described in FIG. 3, a process of determining the unusual damage pattern is described in FIG. 4, and the process of determining the indication(s) of fraud is described in FIG. 5.

FIG. 3 is a flow diagram illustrating a process for determining a fraud in an automobile insurance claim, according to some embodiments.

Step 302 includes the insurance server 104 receiving from a user, an automobile insurance claim for damage to an automobile. The user filed automobile insurance claim may include text data and one or more images associated with the automobile damage (the one or more images may also be collected in step 306). The insurance server 104 may obtain information such as the mobile sensor data and the automobile sensor data from different sources.

Step 304 includes the insurance server 104 registering the automobile insurance claim through the portal provided by the insurance server 104. Step 306 includes the insurance server 104 obtaining one or more images of the damages to the automobile from the user as a part of the automobile insurance claim. The one or more images may be images of the damage caused to one or more zones of the user's automobile. Step 308 includes the insurance server 104 storing the images in the profile database 142.

Step 310 includes retrieving the one or more images from the profile database 142 for processing. Step 312 includes obtaining the text data from the automobile insurance policy. Step 314 includes processing the text data, the one or more images, and the automobile and mobile sensor data to perform the unusual damage pattern detection. In one or more embodiments, the unusual damage pattern detector 134 may perform the unusual damage pattern detection. Step 314A includes the insurance server 104 determining whether there is the unusual damage pattern detected. Determining the unusual damage pattern is described more in detail in FIG. 4.

Step 316 includes processing the one or more images to determine the indication of the fraud. In one or more embodiments, the image processing unit 124 may perform the processing using the ML-based CNN. Determining the indication of the fraud is described more in detail in FIG. 5.

Step 318 includes determining a fraud in the automobile insurance claim based on at least one of the unusual damage pattern and the indication of fraud. In one or more embodiments, the fraud detection unit 136 may perform the determination of step 318.

Step 320 includes performing a human verification on the automobile and/or the one or more images to determine unusual damage pattern and the indication of fraud. In one or more embodiments, the human verification may be performed by the insurance verifier associated with the insurance firm. The human verification output may be provided as an ML parameter update to the CNN. If the human verification indicates no fraud, step 322 includes the insurance server 104, indicating that there is no fraud. If the human verification indicates that there is a fraud, step 342 includes confirming by the insurance server 104, the fraud in the automobile insurance claim based on the human verification.

FIG. 4 is a flow diagram to determine the unusual damage pattern, according to one or more embodiments.

Step 402 includes obtaining the text data provided by the user and processing the text data using the text processing engine to obtain the first set of attributes. In one or more embodiments, the text processing engine may process the text data to obtain such as the location of the incident, date of the incident, time of the incident, and damaged side of automobile and parts as a part of the first set of attributes. The text processing engine may use techniques such as natural language processing to obtain the first set of attributes.

Step 404 includes processing the one or more images to determine the second set of attributes. In one or more embodiments, the image processing unit 124 processes the one or more images. The image processing unit 124 may use the AI to analyze the one or more images. The AI may automatically determine a zone in which the damage is found, identify a type of damage, identifying depth of damage, and an such information. The image processing unit 124 distinguishes and classifies zones and damages to obtain the second set of attributes. The zones may include zone 1-zone 8 and zone 10.

Step 406 includes processing the one or more images to determine the third attribute. In one or more embodiments, the image processing unit 124 may perform the processing of step 406. The third attribute includes details of the damage to the roof of the automobile. For example, the image processing unit 124 uses AI to determine whether there is an image to the roof of the automobile and whether there is a damage to the roof of the automobile, when the roof or zone 9 is identified. In an example, the zone 9 represents the roof of the automobile. In some examples, step 406 may be merged with step 404 or performed separately.

Parallelly or sequentially, the claim processing unit 114 may process the automobile sensor data and/or the mobile sensor data. In step 408, it may be determined whether the automobile is a part of connected automobiles. In one example, the connected automobiles may refer to a fleet of vehicles. If the automobile is not a part of the connected automobiles, step 410 is executed. Step 410 includes obtaining FCD by processing the mobile sensor data to generate the fourth set of attributes. In an example, the mobile sensor data processing unit 126 determines the FCD using techniques such as the floating cellular data technique. If the automobile is not a part of connected automobiles to the car, then step 412 is executed. Step 412 includes obtaining and processing the OBUs sensors data to obtain the fifth set of attributes. In an example, the automobile sensor data processing unit 128 may process the OBUs sensor data.

Step 414 includes processing the second set of attributes, the third attribute, and the fourth set of attributes to obtain the sixth set of attributes. In one or more embodiments, the damage zone and FCD collection unit 132 performs the processing of step 414. The sixth set of attributes are indicative of the at least one of information of damage to one or more zones of the automobile and the FCD attributes.

Step 416 includes processing the fifth set of attributes to obtain the seventh set of attributes that provide damage information associated with the automobile, and location information. In one or more embodiments, the incident damage zone and location unit 130 performs the processing of step 416. Step 418 includes processing the first set of attributes, the sixth set of attributes, and the seventh set of attributes to identify the zones that show damage and whether there is damage to the roof of the automobile. In one or more embodiments, the incident damage zone and location unit 130 may perform the processing of step 418.

Step 420 includes determining whether there is damage to the roof of the automobile. If there is damage to the roof of the automobile, in step 422, perform the first analysis on the first set of attributes, the sixth set of attributes, and the seventh set of attributes to determine whether there are damages to one or more zones on opposite sides of the automobile when the third attribute indicates damage to the automobile roof. In one embodiment, a cognition rule-based decision is used for performing the first analysis. An example cognition rule-based decision for performing the first analysis when the third attribute indicates a damage to the automobile roof is provided below.

{(Zone1\hat{ }Zone6)/(Zone1\hat{ }Zone7)/(Zone1\hat{ }Zone6\hat{ }Zone7)}\hat{ }Zone9 Rule 1

[(Zone2\hat{ }Zone5)/(Zone2\hat{ }Zone7)/(Zone2\hat{ }Zone8) . . . /(Zone2\hat{ }{(Zone5\hat{ }Zone7)/(Zone5\hat{ }Zone8)/(Zone7\hat{ }Zone8)} . . . /(Zone2\hat{ }Zone5\hat{ }Zone7\hat{ }Zone8)]\hat{ }Zone9 Rule 2

[(Zone3\hat{ }Zone4)/(Zone3\hat{ }Zone6)/(Zone3\hat{ }Zone8) . . . /(Zone3\hat{ }{(Zone4\hat{ }Zone6)/(Zone4\hat{ }Zone8)/(Zone6\hat{ }Zone8) } . . . /(Zone3\hat{ }Zone4\hat{ }Zone6\hat{ }Zone8)]\hat{ }Zone9 Rule 3

Zone4\hat{ }Zone5\hat{ }Zone9 Rule 4

Zone8 Zone10 Zone9 Rule 5

(Zone1/Zone2/Zone3/Zone4/Zone5/Zone6/Zone7/Zone8/Zone10)\hat{ }Zone9 Rule 6

Zone1\hat{ }Zone2\hat{ }Zone3\hat{ }Zone4\hat{ }Zone5\hat{ }Zone6\hat{ }Zone7\hat{ }Zone8\hat{ }Zone9\hat{ }Zone10, Rule 7

Additional miscellaneous rules Rule 8

The “\hat{ }” represents “AND” function, while “/” represents “OR” function.

Step 424 includes performing the second analysis on the first set of attributes, the sixth set of attributes, and the seventh set of attributes to determine whether there are damages to one or more zones on opposite sides of the automobile when the third attribute indicates no damage to the automobile roof. In one embodiment, the cognition rule-based decision is used for performing the first analysis. An example cognition rule-based decision for performing the second set of analysis when the third attribute indicates no damage to the automobile roof is provided below.

(Zone1\hat{ }Zone6)/(Zone1\hat{ }Zone7)/(Zone1\hat{ }Zone6\hat{ }Zone7) Rule 1

(Zone2\hat{ }Zone5)/(Zone2\hat{ }Zone7)/(Zone2\hat{ }Zone8) . . . /(Zone2\hat{ }{(Zone5\hat{ }Zone7)/(Zone5\hat{ }Zone8)/(Zone7\hat{ }Zone8)} . . . /(Zone2\hat{ }Zone5\hat{ }Zone7\hat{ }Zone8) Rule 2

(Zone3\hat{ }Zone4)/(Zone3\hat{ }Zone6)/(Zone3\hat{ }Zone8) . . . /(Zone3\hat{ }{(Zone4\hat{ }Zone6)/(Zone4\hat{ }Zone8)/(Zone6\hat{ }Zone8)} . . . /(Zone3\hat{ }Zone4\hat{ }Zone6\hat{ }Zone8) Rule 3

Zone4\hat{ }Zone5 Rule 4

Zone8\hat{ }Zone10 Rule 5

Zone1\hat{ }Zone2\hat{ }Zone3\hat{ }Zone4\hat{ }Zone5\hat{ }Zone6\hat{ }Zone7\hat{ }Zone8\hat{ }Zone10 Rule 6

Additional miscellaneous rules Rule 7

The “\hat{ }” represents “AND” function, while “/” represents “OR” function.

Step 426 includes determining whether the first analysis and/or the second analysis returns an output of true value. If there is an output of true value, then the unusual damage pattern detector 134 indicates that the damage to the automobile demonstrates the unusual damage pattern.

FIG. 5 depicts a flow diagram to determine an indication of the fraud, according to some embodiments.

Step 502 includes retrieving images from the database for fraud detection. In step 504, the images are represented by a red-green-blue (RGB) image format. The RGB image format that is also referred to as a truecolor image is represented by a M×N×3 data array that defines red, green, and blue color components for each individual pixel, where M is the number of rows, and N is the number of columns.

In step 506, the RGB image format is processed by the image processing unit 124 using CNN to determine pre-existing damage. A manual process of determining pre-existing damage is highly non-reliable and error-prone as it is challenging for a human to differentiate the pre-existing damage with the current damages in many cases. Some examples where pre-existing damage may be identified include a presence of rust that indicates that the damage occurred in the past period, damages at places which is away from zones that experienced a collision, and such damages. Unless images of the automobile before the incident is available, it is difficult to determine the pre-existing damage. Thus, image processing using ML-based CNN is used. As a part of training the image processing unit 124 using CNN to determine pre-existing damage, a large data set of existing images are used. For example, over 5000 different images having damages to various zones is used (in some examples, images without damages are also used). In an example, the data may be split to 80%-20%, with 80% of the data used for training and 20% of the data used for testing. Further, the CNN architecture may be formed using two or more convolution layers, pooling layers, fully connected layers and softmax layers. Each convolutional layer may be set with a defined filter size. A rectified linear unit (RELU) non-linearity may be used for every convolutional layer, and appropriate weights are provided. The trained CNN may perform the analysis on the one or more images to determine the presence of pre-existing damages. Step 506 may output a logical 1 in response to pre-existing damage, and a logical 0 when there is no pre-existing damage.

In step 508, the RGB image is processed by the image processing unit 124 using parallel CNN based color matching. Similar to pre-existing detection, image processing using ML-based parallel based CNN color matching is used for the identification of fraud. As a part of training the image processing unit 124 using CNN to perform color matching, a large data set of existing images are used. For example, over 5000 different images having different colors are used. The dataset may be augmented and classified for further process. Further, the CNN architecture may be formed using multiple convolution layers, pooling layers, fully connected layers and software layers. Each convolutional layer may be set with a defined filter size. A rectified linear unit (RELU) non-linearity may be used for every convolutional layer, and appropriate weights are provided. The trained CNN may perform the analysis on the one or more images to match the colors of the one or more images to determine if the images indeed belong to the same automobile and whether the automobile in the one or more images is indeed automobile of the user. Step 508 may output a logical 1 in response to no existing match and a logical 0 when there is a match found.

In step 510, the RGB image is processed by the image processing unit 124 to detect double JPEG compression using custom CNN. In image processing using ML-based CNN for double JPEG compression, images that are not tampered, and images that are tampered are provided to the CNN training. A large dataset of image sets (that is the images that are not tampered and correspond images that are tampered) are provided to CNN for training. Also, a portion of about 10%-20% of the dataset is used for testing. Further, a custom CNN architecture may be formed using multiple convolution layers, pooling layers, fully connected layers, and softmax layers. Each convolutional layer may be set with a defined filter size. For the convolutional connections, an appropriate kernel size (M×N) along with a definition for the number of kernels (k), and stride (s) is set. For the pooling connections, an appropriate pooling size (m×n), and pooling stride (s) 2, and type of pooling (for example, max pooling or average pooling) is set. Each full connection has a defined number of neurons, and the output of the last neuron is sent to a two-way softmax connection, which produces the probability that each sample is classified into each class. In the CNN network, ReLUs with an activation function are used for each connection. The trained CNN may perform the analysis on the one or more images to determine whether there are any double JPEG compression images. Step 510 may output a logical 1 in response to determining double JPEG compression, and a logical 0 when there are only single JPEG images found.

In step 512, the ML based fraud identifier processes the results of the image processing unit 124 for the pre-existing damage using the CNN, the parallel CNN based color matching, and the double JPEG compression using custom CNN to determine any indication of fraud.

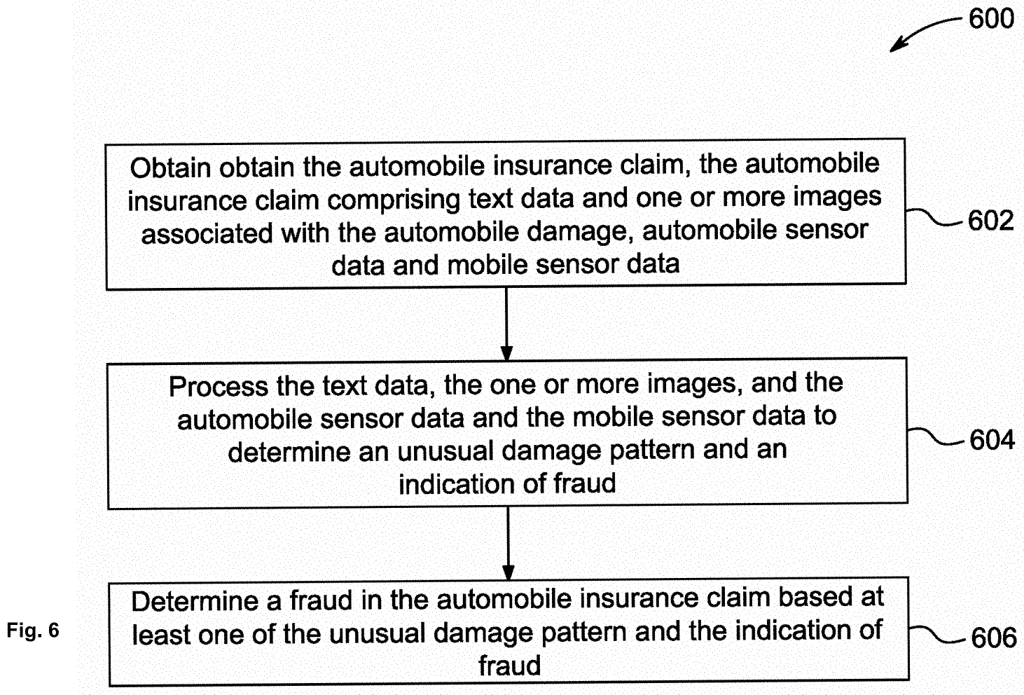

FIG. 6 depicts a process flow 600 for detecting a fraud in an automobile insurance claim, according to some embodiments.

Step 602 includes obtaining the automobile insurance claim. The automobile insurance claim includes text data, one or more images associated with the automobile damage, and automobile sensor data, and mobile sensor data.

Step 604 includes processing the text data, the one or more images, and the automobile and mobile sensor data to determine an unusual damage pattern and an indication of fraud.

Step 606 includes determining fraud in the automobile insurance claim based on the unusual damage pattern and the indication of fraud.

While various embodiment variants of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

The described intelligent fraud detector has the advantage to provide an automated device/system and method for processing digital images and/or optical sensory data (e.g. still images or video images) to automatically provide specific measures, such as, (i) triage results (e.g. a car is repairable or a total loss), (ii) detection of potentially suspicious (i.e. manipulated) images, (iii) detection of potential fraud utilizing specific data extracted from the image data and/or received from suitable databases (i.e. industry fraud databases, e.g. a insurance fraud register, a motor insurance database, a DVLA, vehicle register or VIN check to check the history of a vehicle), and other relevant data, (vi) repair time, (v) required parts, (vi) cost to repair/replace parts. With the fraud detector, images can be processed at any stage during the risk-transfer claim lifecycle and can be used across varying product lines, such as, for example, first notification of loss (FNOL) for motor vehicles and/or homes etc.

### (B) Automated Damage Recognition and Classification

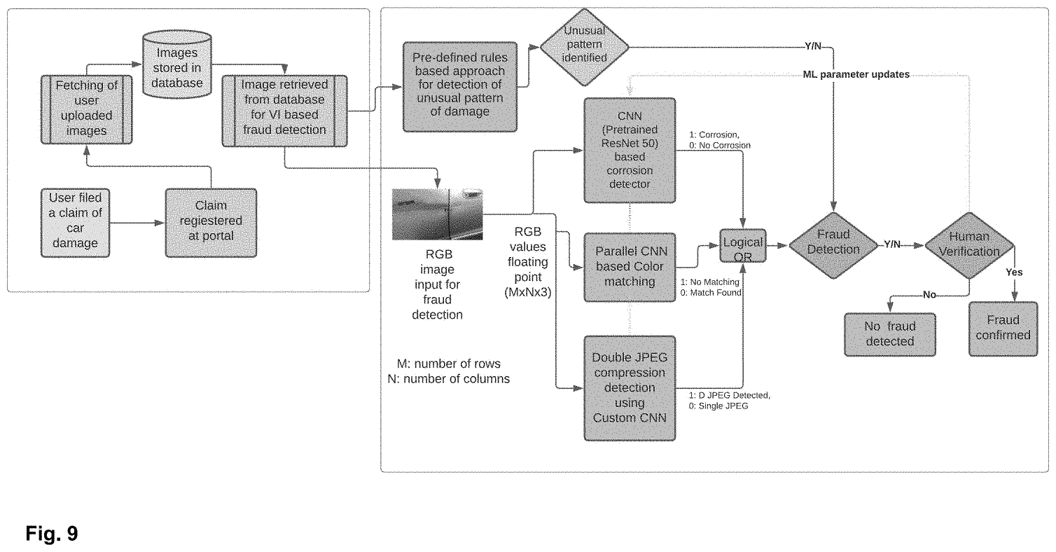

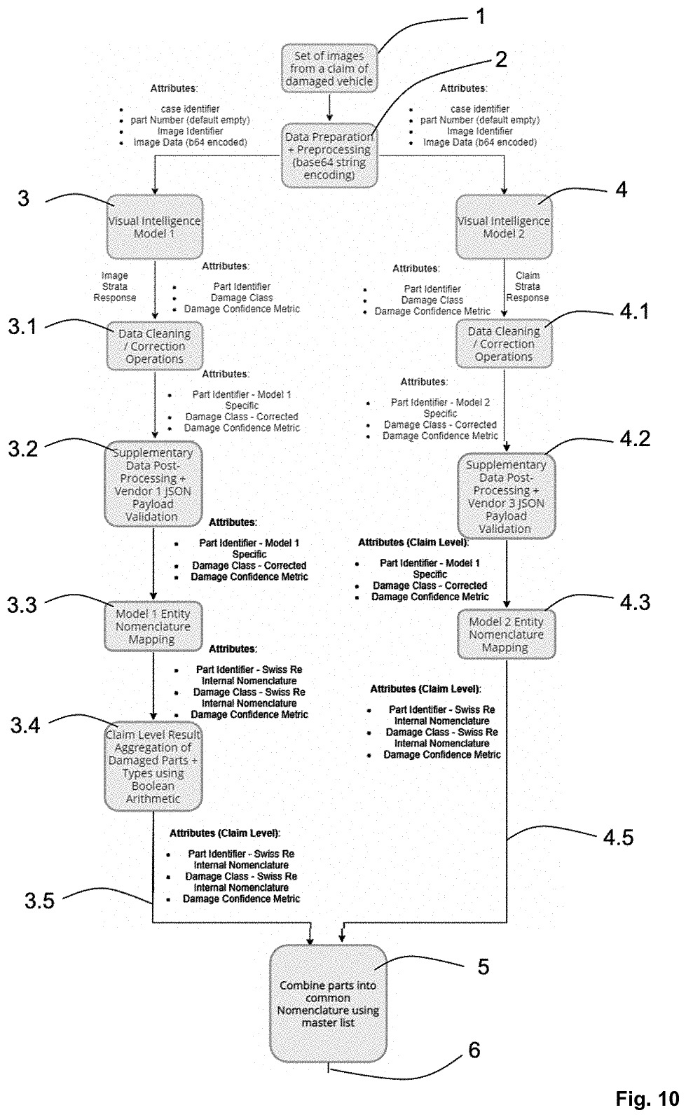

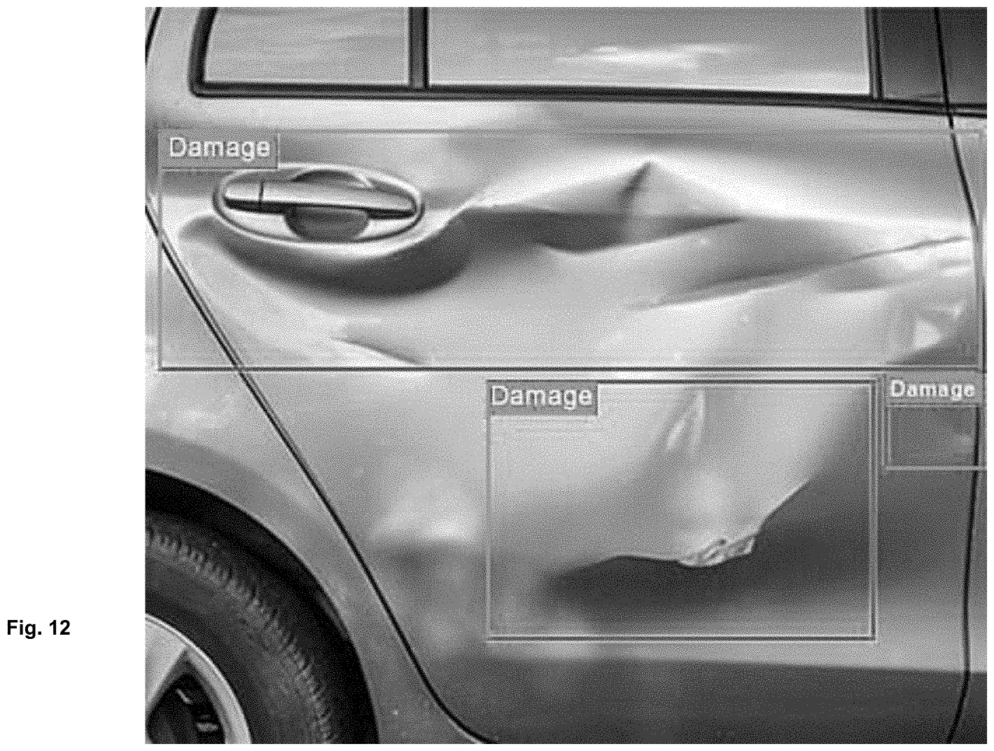

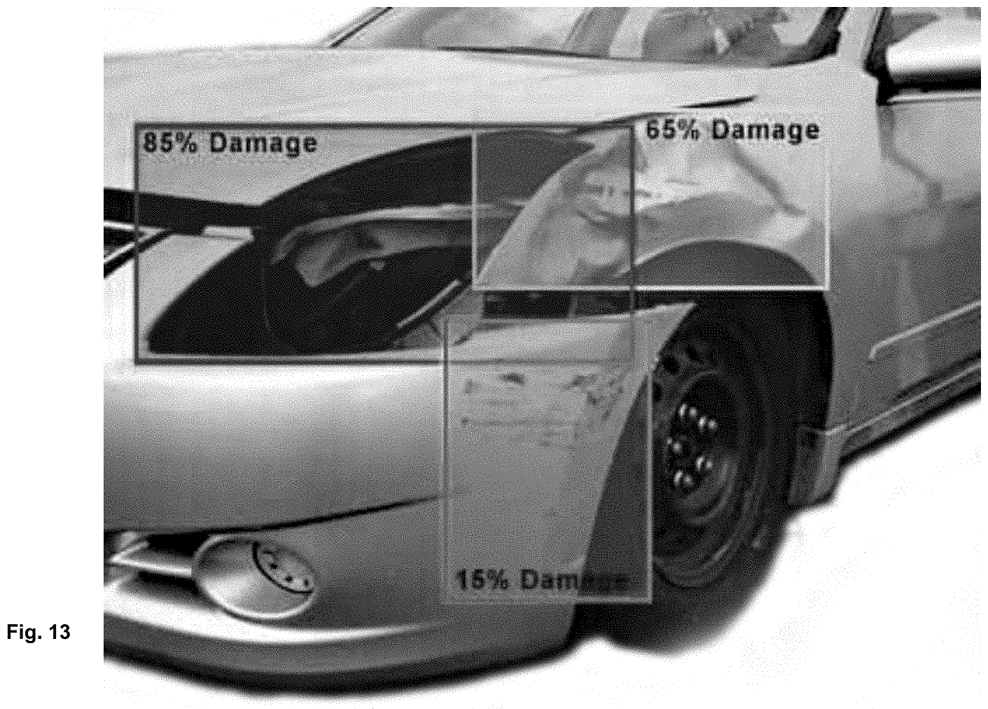

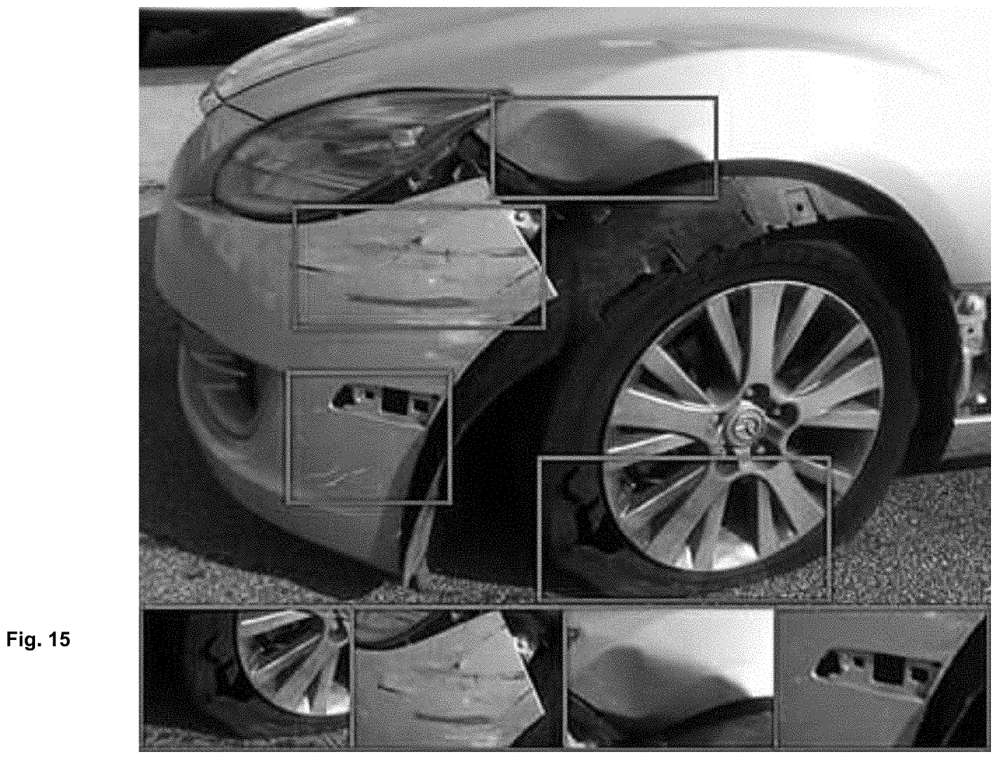

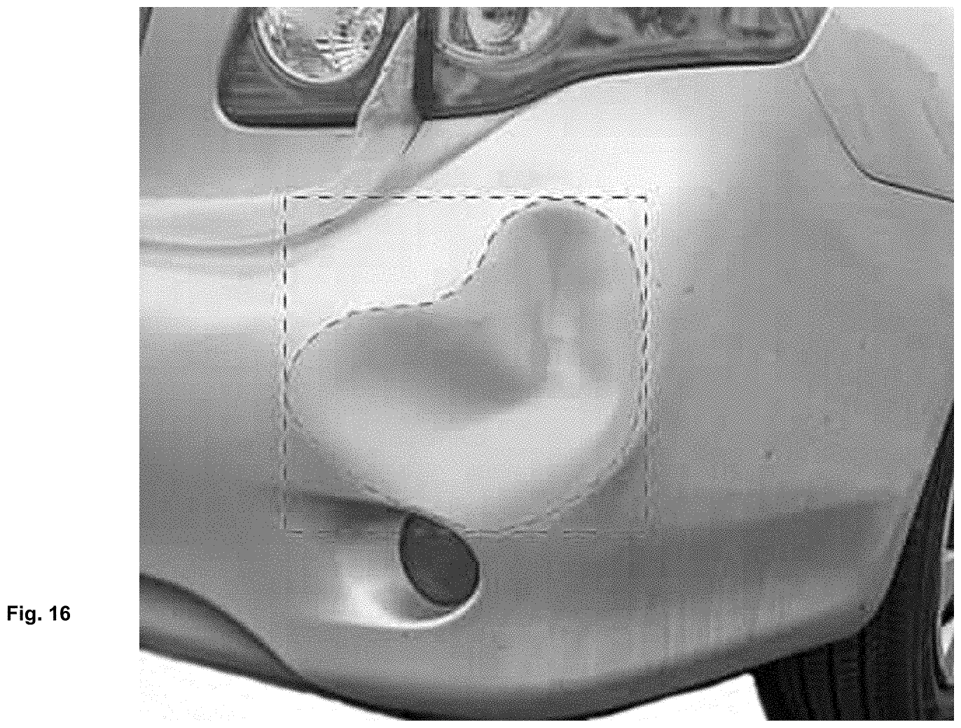

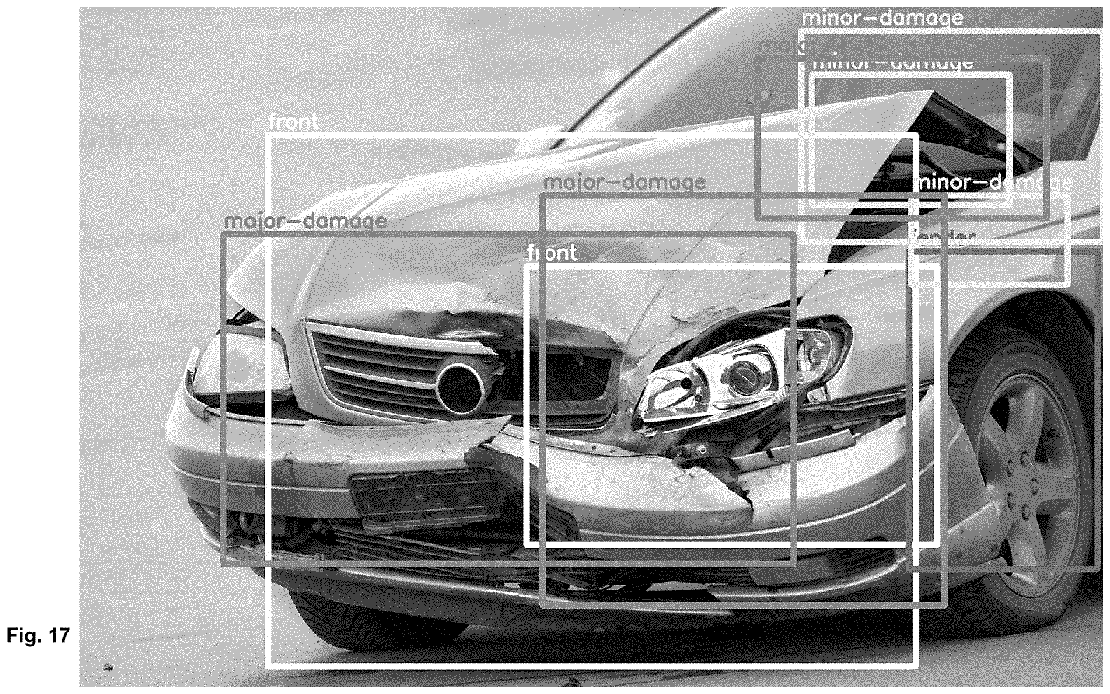

The embodiment variant with the novel automated damage recognition, as described by the FIGS. 10 to 17, has the novel automated damage recognition realized as an integrated part of the fraud detector as described by the FIGS. 1 to 9. However, it is explicitly to be noted, that the automated damage recognition, as described by the FIGS. 10 to 17 can be used independent from the fraud detector as described by the FIGS. 1 to 9, for example as part or stand-alone system for image processing and automated damage recognition and/or classification.

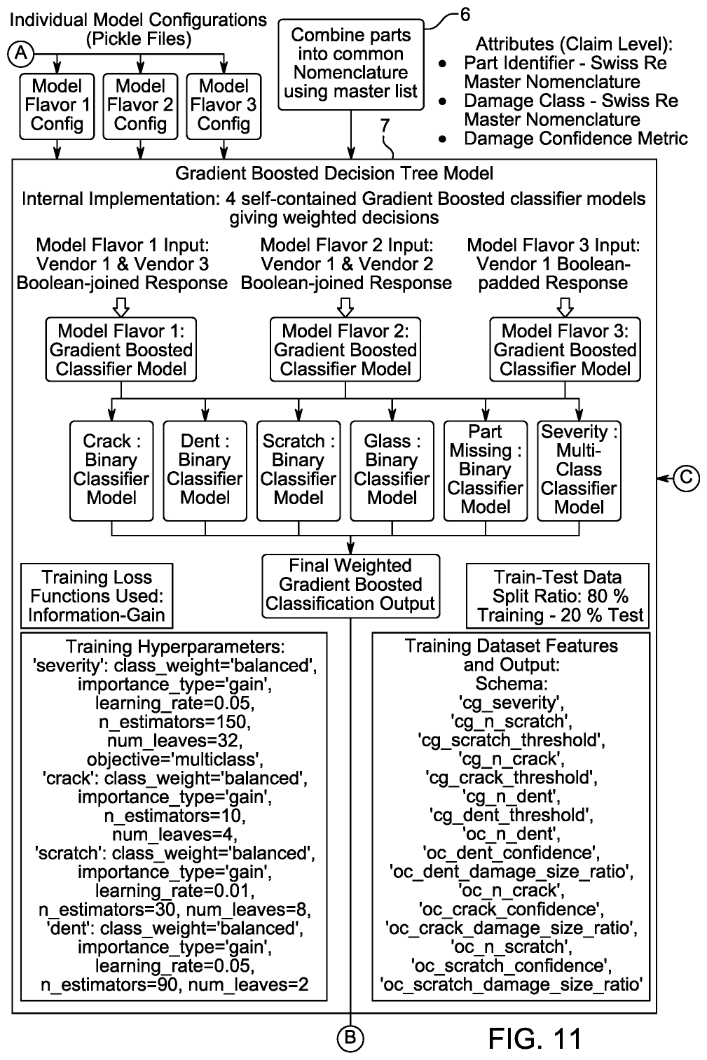

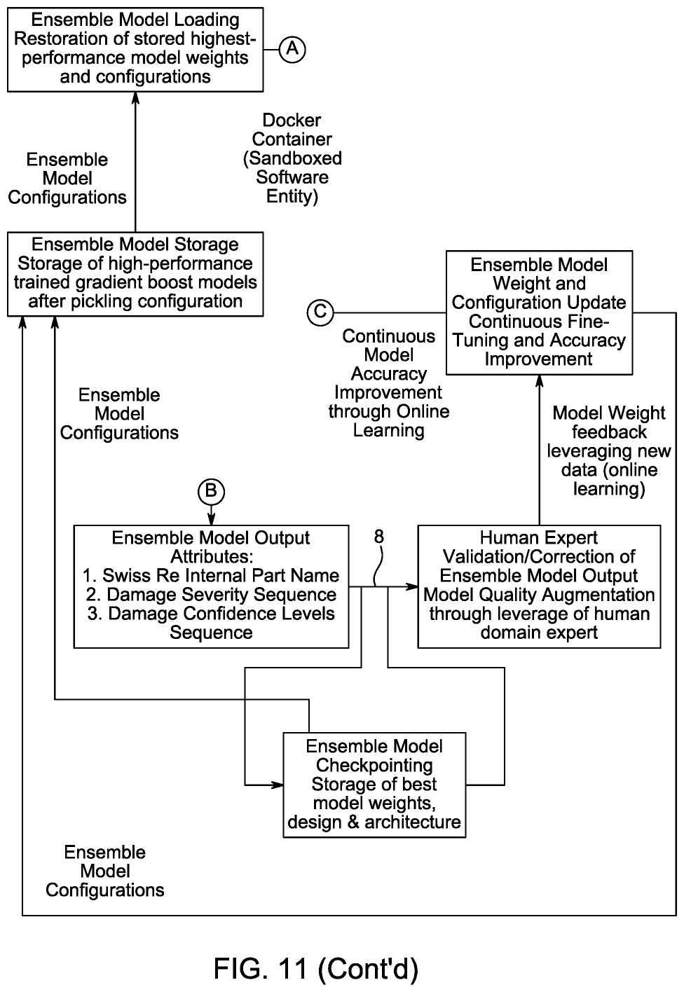

In FIGS. 10 and 11, an example of a recognition method for automated damage identification for vehicle or property damages based on image processing is illustrated. The recognition method can for example be executed with a recognition apparatus comprising a damage data upload section, at least one data storage unit, an image processing section, a damage identification section and a damage information output section.

FIG. 10 depicts a first cycle of the inventive recognition method that identifies and determines a damage and damage type at a vehicle like a car for example. One or more images captured of the damage at the vehicle provide image data that is uploaded in an uploading step 1 and provided for further processing by the recognition method according to the invention. The image data is preprocessed in a preprocessing step 2 by associating additional image information to the image data like for example a case identifier, a part number or an image identifier.

In an image processing step the image data is processed by independently applying different visual models to the image data in a first visual processing step 3 and simultaneously in a second visual processing step 4. The first and the second visual processing steps 3 and 4 independently identify damaged parts of the vehicle and damage types at the vehicle. Each visual model provides an independent sub set of damage data corresponding to the identified damaged parts and damage types.

In the first visual processing step 3 the image data is subject of:
A data cleaning & correction step 3.1
A data post-processing step 3.2
A mapping step 3.3 for associating a nomenclature to the identified damage
A Boolean arithmetic processing step 3.4
Defining a first sub set of damage data 3.5 comprising information about the damage and the damage type according to the output of the first visual processing step 3.

In the second visual processing step 4 the image data is processed by the second visual model by applying:
A data cleaning & correction step 4.1,
A data post-processing step 4.2,
A mapping step 4.3 for associating a nomenclature to the identified damage, and
Defining a second sub set of damage data 4.5 comprising information about the damage and the damage type according to the output of the second visual processing step 4.

As discussed above, the second visual model differs from the first visual model. Next, in a combining step 5 the sub sets of damage data 3.5 and 4.5 are automatically combined to define a single domain of damage data 6 that provides enhanced inference accuracy for identifying the damaged parts of the vehicle and the damage type.

As a result damage information based on the single domain of damage data 6 is provided that indicates the damaged parts and damage types of the vehicle. The damage data provides more precise information about the damage and the damage type as each of the visual models could provide by themselves. The recognition method according to the invention provides an ensemble model structure that utilizes a novel processing pipeline by amalgamating outputs of the two visual models. Preferably, the visual models are chosen from visual intelligence models. The ensemble model structure reducers individual model deficiencies and enhances inference accuracy of each model. As a result, the proposed ensemble model structure achieves higher accuracy in detecting damaged parts and corresponding damage types on the vehicle that can for example be used in claim image processing.

The recognition method and apparatus for automated damage identification for vehicle or property damages as shown in FIG. 10 can be further enhanced in a second data processing cycle, wherein the system processes the images further using a gradient boosted decision tree model structure as illustrated in FIG. 11. In the second cycle the ensemble model structure with the single domain of damage data serves as the basis for the gradient boosted decision tree model structure. In the example shown in FIG. 11 the single domain of damage data is subject to classifier models that provide weighted decisions about the damage data. Three independent model flavors 7.1, 7.2 and 7.3 are applied to the single domain of damage data.

In still a further improvement of the recognition method and apparatus for automated damage identification for vehicle or property damages as shown in FIG. 10, the ensemble model output is used to improve the machine learning based on a human expert validation/correction feedback loop 8.

This description and the accompanying drawings that illustrate aspects and embodiments of the present invention should not be taken as limiting the claims defining the protected invention. In other words, while the invention has been illustrated and described in detail in the drawings and foregoing description, such illustration and description are to be considered illustrative or exemplary and not restrictive. Various compositional, structural, and operational changes may be made without departing from the spirit and scope of this description and the claims. In some instances, well-known processes, structures and techniques have not been shown in detail in order not to obscure the invention. Thus, it will be understood that changes and modifications may be made by those of ordinary skill within the scope and spirit of the following claims.

In the claims the word “comprising” does not exclude other segments or steps, and the indefinite article “a” or “an” does not exclude a plurality. A single unit or step may fulfil the functions of several features recited in the claims. The mere fact that certain measures are recited in mutually different dependent claims does not indicate that a combination of these measures cannot be used to advantage. Any reference signs in the claims should not be construed as limiting the scope.

The recognition method and apparatus for automated damage identification according to the present invention may be designed as a computer program stored/distributed on a suitable medium, such as an optical storage medium or a solid-state medium supplied together with or as part of other hardware, but may also be distributed in other forms, such as via the internet or other wired or wireless telecommunication systems. In particular, e.g., the computer program can be a data structure product and/or a computer program product stored on a computer readable medium which can have computer executable program code adapted to be executed to implement a specific method such as the method according to the invention.

### REFERENCE LIST

### (A) Automated Fraud Detection

100 Automated automobile claim fraud detection system/Automated automobile claims fraud detector
102 User device/network-enabled client
   1021 Mobile device/smart phone
104 Automated risk-transfer system/Automated insurance system
   1041 Claim portal
      1042 Optical sensory data/digital images
      1043 Automotive sensory measuring data/connected car sensory data
      1044 Text data
         10441 Incident description data
         10442 Damage description data
   112 User management unit
   114 Claim processing unit
   116 Output signaling unit
   122 Text processing and recognition unit
   124 Image processing and recognition unit
   126 Mobile sensor data processing unit
   128 Automobile sensor processing unit
   130 Incident damage zone and location unit
      1301 Damage location zones
      1302 Incident geographic location
      1303 Incident date
      1304 Incident time/incident temporal occurrence
   132 Damage zone and FCD collection unit
   134 Unusual damage pattern detector
      1341 Unusual pattern detection structure
      1342 First fraud detection unit
         13421 Rul-based fraud identifier
   136 Machine-learning-based fraud detection unit
      1361 RGB recognition or identification module
      1362 RGB values of a digital image
      1363 Second fraud detection unit
         13631 ML-based fraud identifier
   140 Signal assembling unit
      1401 Fraud detection signaling output
      1402 Automated feedback loop
      1403 Verified fraud detection signaling output
   138 Data storage/persistence storage
   152 Persistence storage/Memory module
   154 Data processor
106 Verifier's device
108 Motor vehicle
   1081 Automotive sensors/connected vehicle sensors
   1082 Telematic device for transmitting automotive sensory data
   1083 Damaged objects
110 Data transmission network

### (B) Automated Damage Recognition and Classification

1 Image data uploading step

2 Image data preprocessing step

3 first visual model processing step
3.1 data cleaning and correction step
3.2 data post processing step
3.3 mapping step
3.4 Boolean arithmetic processing step
3.5 first sub set of data of first visual model

4 second visual model processing step
4.1 data cleaning and correction step
4.2 data post processing step
4.3 mapping step
4.5 second sub set of data of second visual model

5 Combining step

6 single domain of damage data

7 gradient boosted decision tree structure
7.1 first model flavor
7.2 second model flavor
7.3 third model flavor

8 feedback loop

1. An automated automobile claims fraud detector providing an automated verification process of validity and extent of at least one damaged object of a motor vehicle based on digital image data, the automated automobile claims fraud detector comprising:
circuitry configured to:
capture damage related data at least comprising one or more digital images and/or automotive sensory data and/or text data, the one or more digital images at least comprising digital images associated with one or more damaged objects of the motor vehicle,
receive data via a data transmission network, the received data including car sensor data, and/or floating cellular data from mobile devices, and/or installed on-board unit devices data,
predict or determine at least damage location zones and/or an incident geographic location and/or an incident date and/or an incident time based processing on the received data,
process said one or more digital images for existing image alteration by using an unusual pattern identification structure as a first fraud detection,
process, via an RGB recognition module, said one or more digital images for fraud detection using an RGB image input, RGB values of the RGB image input being used for (i) convolutional neural network (CNN)-based pre-existing damage detection, (ii) parallel CNN-based color matching, and (iii) double JPEG compression detection using custom CNN,
trigger a machine learning (ML)-based fraud identifier based on the (i) CNN-based pre-existing damage detection, (ii) parallel CNN-based color matching, and (iii) double JPEG compression detection using custom CNN as a second fraud detection, and
generate a fraud signaling output based upon detecting a rule-based fraud identifier and/or the ML-based fraud identifier.

2. The automated automobile claims fraud detector according to claim 1, wherein the circuitry is configured to feedback a verified signaling output and update ML parameters of the CNN-based pre-existing damage detection and/or of the parallel CNN-based color matching and/or of the double JPEG compression detection using custom CNN.

3. An automated fraud detection method for detecting a fraud in digital images associated with an automobile claim and a related risk-transfer using an automated system, the automated system being accessed by client devices over a network via an electronic claim portal of the automated system acting as an interface between the client devices and the automated system for transmitting automobile risk-transfer claim data via the electronic claim portal to the automated system, and the automobile risk-transfer claim data comprising text data and one or more digital images of an automobile damage and/or automobile sensor data and/or mobile sensor data, the method comprising:
processing the text data, the one or more digital images, the automobile sensor data, and the mobile sensor data to determine an unusual damage pattern and/or an indication of fraud, the unusual damage pattern being associated with a damage to an automobile that is unlikely to have happened to the automobile due to an accident, and/or the indication of fraud being an indication that the one or more digital images are tampered, and
determining a fraud in the automobile claim based on at least one of the unusual damage pattern and/or the indication of fraud.

4. The automated fraud detection method according to claim 3, further comprising processing the text data using natural language processing techniques to determine a first set of attributes, the first set of attributes including at least one of a car location, a date of the accident, a time of the accident, and a damaged side of the automobile and parts.

5. The automated fraud detection method according to claim 4, further comprising processing the one or more digital images using an Artificial Intelligence (AI) structure to:
determine a second set of attributes indicative of damage to one or more zones of the automobile, the second set of attributes including details of damage to at least one zone of the one or more zones including a front center zone, a front left zone, a front right zone, a left zone, a right zone, a rear left zone, a rear right zone, a rear center zone, and a windshield zone; and
determine a third attribute, the third attribute comprising details of damage to a roof of the automobile.

6. The automated fraud detection method according to claim 5, further comprising processing the mobile sensor data to obtain floating car data (FCD) and/or on-board units (OBUs) sensors data.

7. The automated fraud detection method according to claim 6, further comprising:
processing the FCD to determine a fourth set of attributes, the fourth set of attributes including at least one of a passenger's route, a trip travel time, an estimated traffic state, and global positioning system (GPS) data, and
processing the second set of attributes, the third attribute, and the fourth set of attributes to obtain a sixth set of attributes, the sixth set of attributes including at least one of information of the damage to the one or more zones of the automobile and FCD attributes,
wherein the FCD attributes include timestamped geo-localization and speed data.

8. The automated fraud detection method according to claim 7, further comprising:
processing the OBUs sensors data to obtain a fifth set of attributes, the fifth set attributes including at least one of a camera data, a speed data, engine revolutions per minute (RPM) data, a rate of fuel consumption, the GPS data, a moving direction, impact sensor data, and airbag deployment data, and
processing the fifth set of attributes to obtain a seventh set of attributes that provide damage information associated with the automobile and location information, the seventh set of attributes including at least one of the information of the damage to the one or more zones of the automobile and the GPS data.

9. The automated fraud detection method according to claim 8, further comprising:
performing a first analysis on the first set of attributes, the sixth set of attributes, and the seventh set of attributes to determine whether there is damage to one or more zones on opposite sides of the automobile when the third attribute indicates damage to the automobile roof,
performing a second analysis on the first set of attributes, the sixth set of attributes, and the seventh set of attributes to determine whether there is the damage to one or more zones on opposite sides of the automobile when the third attribute indicates no damage to the automobile roof, and
determining the unusual damage pattern based on the first analysis and the second analysis.

10. The automated fraud detection method according to claim 3, further comprising processing the one or more digital images by using a convolutional neural network (CNN) structure to:
(i) identify at least one of a pre-existing damage, a color matching, and a double joint photographic experts group (JPEG) compression, and
(ii) determine the indication of the fraud based on identifying the at least one of the pre-existing damage, the color matching, and the double JPEG compression.

11. The automated fraud detection method according to claim 10, further comprising providing a machine learning (ML) parameter update to the CNN based on human verification.

12. The automated automobile claims fraud detector according to claim 1, wherein the circuitry is further configured to:
receive one or more captured images of damage at a vehicle or property in a form of digital image data that is uploaded into at least one data storage,
process the digital image data by independently applying at least two different visual modeling data processing structures to the digital image data to independently identify damaged parts of the vehicle or property and/or damage types at the vehicle or property, each of the visual modeling data processing structures providing an independent sub set of damage data corresponding to the identified damaged parts and/or damage types,
automatically combine the independent sub sets of damage data to define a single domain of damage data that provides enhanced inference accuracy for identifying the damaged parts of the vehicle or property and/or the damage types, and
provide damage information based on the single domain of damage data.

13. The automated automobile claims fraud detector according to claim 12, wherein the circuitry is further configured to:
check the independent sub sets of damage data for data deficiencies regarding the damaged parts of the vehicle or property, and
compensate for the data deficiencies in one sub set of damage data by damage data of another sub set of damage data to provide the enhanced inference accuracy of the single domain of damage data.

14. The automated automobile claims fraud detector according to claim 12, wherein the circuitry is further configured to:
provide a master list of damage nomenclature,
compare the single domain of damage data representing the identified damaged parts and/or damage types to the master list of damage nomenclature to associate the identified damaged parts and/or damage types to corresponding damage nomenclature.

15. The automated automobile claims fraud detector according to claim 12, wherein the circuitry is further configured to process the digital image data by a gradient boosted decision tree model.

16. The automated automobile claims fraud detector according to claim 12, wherein the circuitry is further configured to augment the combining of the independent sub sets of damage data by a validation factor corresponding to human expert validation of the damage information.

17. The automated fraud detection method according to claim 3, further comprising:
receiving one or more captured images of damage at a vehicle or property in a form of digital image data that is uploaded into at least one data storage,
processing the digital image data by independently applying at least two different visual models to the digital image data to independently identify damaged parts of the vehicle or property and/or damage types at the vehicle or property, each of the visual models providing an independent sub set of damage data corresponding to the identified damaged parts and/or damage types,
automatically combining the independent sub sets of damage data to define a single domain of damage data that provides enhanced inference accuracy for identifying the damaged parts of the vehicle or property and/or the damage types, and
providing damage information based on the single domain of damage data.

18. The automated fraud detection method according to claim 17, further comprising providing the digital image data with a case identifier, a damage part number, and/or an image identifier.

19. The automated fraud detection method according to claim 17, wherein at least one of the visual models provides damage part identification, damage class identification, and/or assigning a damage confidence metric to the damage data.

20. The automated fraud detection method according to claim 17, wherein at least one of the visual models provides data cleaning and/or data correction including correction of the damage part and/or damage classification.

21. The automated fraud detection method according to claim 17, wherein
at least one of the visual models associates the damage data with a predefined damage nomenclature and/or predefined damage classification, and
the predefined damage nomenclature and/or classification is selected from a master list of damage nomenclature.

22. The automated fraud detection method according to claim 17, wherein
the single domain of damage data is processed by a gradient boosted decision tree model using at least two self-contained gradient boosted classifier models giving weighted damage data, and
the weighted damage data is amalgamated to provide damage information as ensemble model output.

23. The automated fraud detection method according to any claim 22, further comprising:
subjecting the single domain of damage data and/or the ensemble model output to a feedback loop based on human expert validation, and
applying a validation factor corresponding to the expert validation to the damage data.

24. The automated fraud detection method according to claim 17, wherein the at least two visual models are visual intelligence models.
